(19) United States
(12) Patent Application Publication
(10) Pub. No.: US 2010/0235684 A1
(43) Pub. Date: Sep. 16, 2010

(54) STORAGE SYSTEM, ADAPTER, AND DIAGNOSIS PROCESSING METHOD

(75) Inventor: Tomoharu MURO, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/719,261

(22) Filed: Mar. 8, 2010

(30) Foreign Application Priority Data
Mar. 10, 2009 (JP) 2009-057116

(51) Int. Cl. G06F 11/28; G06F 9/24

(52) U.S. Cl. 714/37; 713/2; 714/E11.178

(57) ABSTRACT

A storage system for controlling a storage device to store data from a host system, the storage system includes a storage controller for controlling to write to or read data from the storage device, a memory for temporally storing data during performing a data relay processing between the host system and the storage device, and a relay device for performing the data relay processing using the memory. The relay device includes a plurality of processing circuits for performing the data relay processing cooperatively and a self-diagnosis controller for controlling each of the processing circuits to start independently a self-diagnosis processing upon completion of the processing by each of the processing circuit.

### CROSS-REFERENCE TO RELATED APPLICATIONS

This application is based upon and claims the benefit of priority of the prior Japanese Patent Application No. 2009-57116, filed on Mar. 10, 2009, the entire contents of which are incorporated herein by reference.

### FIELD

The embodiments discussed herein are related to a storage system, an adapter, and a diagnosis processing method.

### BACKGROUND

Multiple processing circuits included in an adapter within a storage system cooperatively perform data relay processing between a host server connected to the storage system, and a storage medium within the storage system.

There is known a CRC (Cyclic Redundancy Check) diagnosis technique using CRC as a technique for diagnosing whether or not a processing circuit will function properly. There also is known a circuit diagnosis technique in which a processing circuit diagnoses the circuit itself while the storage system is stopped, and with this circuit diagnosis technique, self-diagnosis processing is executed after processing of all processing circuits has ended. There also has been known a technique in which contents stored in the register of a PCI (Peripheral Components Interconnect) bus controller are periodically reset. Reference documents are Japanese Laid-open Patent Publication No. 05-204772 and Japanese Laid-open Patent Publication No. 2006-155434.

However, there has been a problem with the above-mentioned technique of related art, in that processing circuits may not be appropriately diagnosed. For example, with the CRC diagnosis technique, the diagnosis processing may not be performed in a short time depending on the circuit scale. In addition, with the above circuit diagnosis technique, the circuit is stopped for the diagnosis processing.

### SUMMARY

According to an aspect of the embodiment, a storage system for controlling a storage device to store data from a host system, the storage system includes a storage controller for controlling to write to or read data from the storage device, a memory for temporally storing data during performing a data relay processing between the host system and the storage device, and a relay device for performing the data relay processing using the memory, the relay device includes a plurality of processing circuits for performing the data relay processing cooperatively, and a self-diagnosis controller for controlling each of the processing circuits to start independently a self-diagnosis processing upon completion of the processing by each of the processing circuit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for describing an overview of a relay device according to a first embodiment.

FIG. 2 is a block diagram for describing the configuration of a storage system.

FIG. 3 is a block diagram for describing the configuration of an adapter.

FIG. 4 is a diagram for describing an adapter at the time of read processing.

FIG. 5 is a diagram for describing an adapter at the time of write processing.

FIG. 6 is a block diagram for describing circuits within a memory controller.

FIG. 7 is a diagram for describing timing at which self-diagnosis processing is executed during read processing.

FIG. 8 is a diagram for describing timing at which self-diagnosis processing is executed during write processing.

FIG. 9 is a flowchart for describing the flow of processing in which the circuits are formed in the memory controller.

FIG. 10 is a sequence diagram for describing an overview of the flow of self-diagnosis processing.

FIG. 11 is a diagram for describing the flow of self-diagnosis processing.

FIG. 12 is a diagram for describing the flow of self-diagnosis processing.

FIG. 13 is a block diagram for describing circuits within a memory controller according to a second embodiment.

FIG. 14 is a diagram for describing the flow of self-diagnosis processing in the second embodiment.

FIG. 15 is a diagram for describing the flow of self-diagnosis processing in the second embodiment.

FIG. 16 is a block diagram for describing circuits within a memory controller according to a third embodiment.

FIG. 17 is a diagram for describing the flow of self-diagnosis processing in the third embodiment.

FIGS. 18A and 18B are diagrams for describing the flow of self-diagnosis processing in the third embodiment.

FIG. 19 is a diagram for describing the flow of self-diagnosis processing in a case wherein occurrence of a new memory write instruction is to be permitted.

FIGS. 20A and 20B are diagrams for describing the flow of self-diagnosis processing in a case wherein occurrence of a new memory write instruction is to be permitted.

FIG. 21 is a diagram for describing the flow of self-diagnosis processing in a case wherein occurrence of a new memory read instruction is to be permitted.

FIGS. 22A and 22B are diagrams for describing the flow of self-diagnosis processing in a case wherein occurrence of a new memory read instruction is to be permitted.

### DESCRIPTION OF EMBODIMENTS

Preferred embodiments of the present invention will be explained with reference to accompanying drawings.

Embodiments of the storage system, adapter, and diagnosis processing method will now be described in detail, with reference to the drawings. Note that the embodiments are not restrictive with regard to the art.

### 1. First Embodiment

### Explanation of the Relay Device

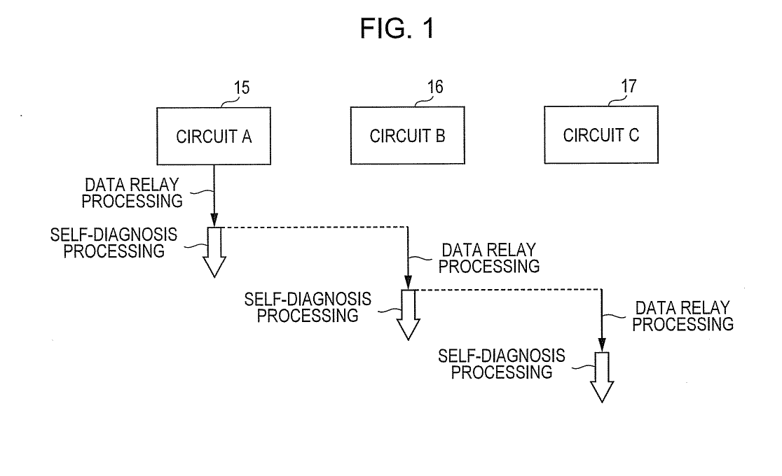

The overview of a relay device according to a first embodiment will be described with reference to FIG. 1. FIG. 1 is a diagram for describing the overview of the relay device according to the first embodiment.

The relay device according to the first embodiment has multiple processing circuits which cooperatively execute data relay processing between a host system and a storage system, and as illustrated in FIG. 1, includes a circuit A 15, a circuit B 16, and a circuit C 17.

As illustrated in FIG. 1, with the relay device according to the first embodiment, upon completion of the processing to be performed by each of the circuits, each of the circuits starts self-diagnosis processing of itself. For example, as illustrated in FIG. 1, the circuit A 15, circuit B 16, and circuit C 17 cooperatively execute data relay processing, and upon completion of the processing to be performed by each of the circuits, each of the circuits starts self-diagnosis processing of itself. For example, as self-diagnosis processing, the circuit A 15, circuit B 16, and circuit C 17 start processing as if predetermined data had been received, and check whether or not the processing results yield a predetermined value.

Accordingly, with the relay device according to the first embodiment, the diagnosis processing may be made in a short time. Specifically, upon completion of the processing to be performed by each of the circuits, each of the circuits starts self-diagnosis processing of itself, so the diagnosis processing may be made in a short time.

### (Construction of the Storage System)

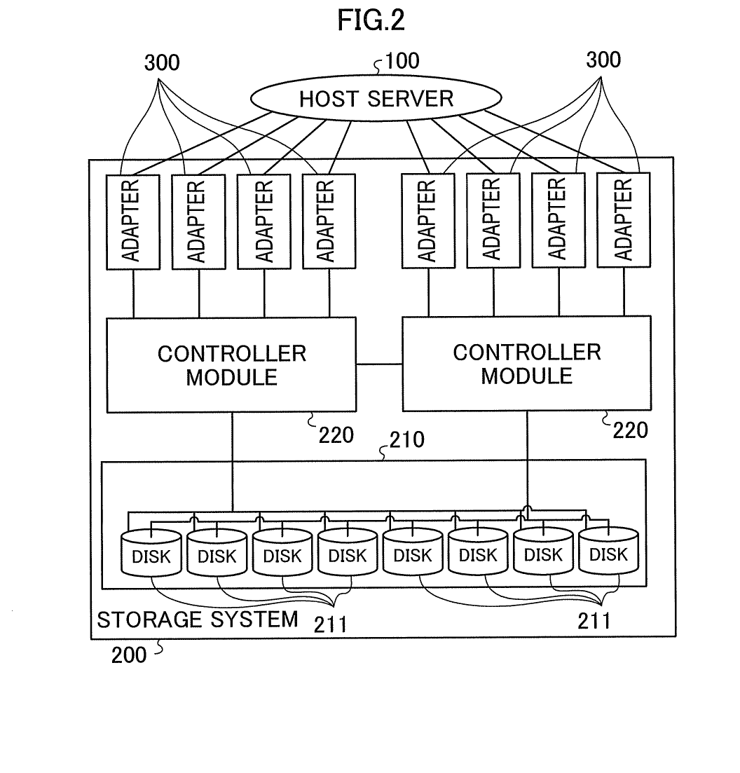

Next, the configuration of a storage system having the relay device (also called “adapter”) described with reference to FIG. 1 will be described. FIG. 2 is a block diagram for describing the configuration of the storage system according to the first embodiment.

As illustrated in FIG. 2, storage system 200 is connected to a host server 100, and includes a disk enclosure 210, multiple controller modules 220, and multiple adapters 300. Also, the storage system 200 is an apparatus storing information used by the host server 100, an example of which is a RAID (Redundant Arrays of Inexpensive Disks) system.

The host server 100 is connected to the storage system 200 and uses the storage system 200 to write and read data. Specifically, at the time of reading data, the host server 100 sends a read instruction to the adapters 300, and at the time of writing data, sends the data to be written and a write instruction to the adapters 300.

The disk enclosure 210 is connected to multiple controller modules 220, and mounts one or multiple disks, an example of which is a housing mounting multiple disks 211. The disks 211 store data used by the host server 100, with data being written thereto by the controller module 220 and also data being read therefrom by the controller module 220, based on instructions from the host server 100.

The controller modules 220 are connected to the disks 211 and multiple adapters 300. Upon receiving a disk write instruction which is an instruction to write data to the disks 211, and also data to be written, from the adapters, the controller modules 220 write the received data to the disks 211. Also, upon receiving a read instruction which is an instruction to read data from the disks 211 from the adapters 300, the controller modules 220 read the data identified by the received information from the disks 211, and transmit this to the adapters 300.

Note that, as illustrated in FIG. 2, the storage system 200 has multiple controller modules 220. This is to realize a storage system 200 with redundancy. For example, even in the event that part of the multiple controller modules 220 fail, the storage system 200 may execute data read and write processing using the properly-functioning controller modules 220.

The adapters 300 are connected to the host server 100 and controller modules 220, and execute data relay processing between the host server 100 and controller modules 220. That is to say, the adapters 300 relay data exchange between the host server 100 and controller modules 220.

### (Construction of the Adapters)

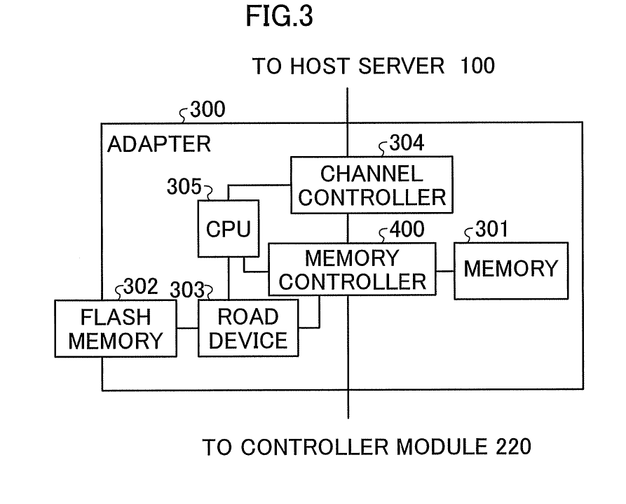

Next, the configuration of the adapters 300 will be described with reference to FIG. 3. FIG. 3 is a block diagram for describing the configuration of the adapters according to the first embodiment. The adapters 300 are also called relay devices, and have multiple processing circuits for cooperatively performing the data relay processing between the host server 100 and controller modules 220.

As illustrated in FIG. 3, an adapter 300 includes memory 301, flash memory 302, a load device 303, a channel controller 304, and CPU (Central Processing Unit) 305, and a memory controller 400.

Note that in the first embodiment, description will be made regarding an arrangement wherein, of the processing circuits which the adapter 300 has, a circuit within the memory controller 400 executes the self-diagnosis processing. Also, details of the memory controller 400 will be described later in detail, so description thereof will be omitted from description of the configuration of the adapter 300 given here with reference to FIG. 3. It should be noted that the circuit for executing self-diagnosis processing is not restricted to a circuit within the memory controller 400, and may be a difference circuit such as the channel controller 304 or the like.

The memory 301 is connected to the memory controller 400. Also, the memory 301 is used for the adapter 300 to execute data relay processing, specifically for the adapter 300 to temporarily store the data being relayed.

Note that the data stored in the memory 301 is written by the memory controller 400, and also read out by the memory controller 400. Also note that the data that has been stored in the memory 301 and relaying thereof has completed is erased by being overwritten by the memory controller 400, for example.

The flash memory 302 is connected to the load device 303. Also, the flash memory stores circuit information functioning as a circuit by being loaded to a programmable device. The circuit information is written in the flash memory 302 by an external device at the time of manufacturing, for example. Hereinafter, flash memory 302 will be understood to have circuit information written therein beforehand, unless specifically stated otherwise.

Examples of programmable devices include FPGA (Field Programmable Gate Array) devices and CPLDs (Complex Programmable Logic Devices). A programmable device loads circuit information from nonvolatile memory outside of the device to circuit-configuring memory within the device, so as to configure a desired device. Note that examples of circuit-configuring memory include SRAM (Static Random Access Memory) and so forth. Exchanging circuit information stored in nonvolatile memory allows circuits to be changed as desired, so correction of logical programs is easier as compared to ASICs (Application Specific Integrated Circuits), and development time may be reduced.

Note that the processing circuit within a programmable device is realized by a predetermined program being loaded to the storage region within the programmable device. Also, there is a great need to diagnose whether or not the processing circuit within the programmable device is functioning properly, since the programmable device will cease to function properly if an error occurs in the storage region due to the effects of neutron beams or the like.

Also, with the first embodiment, the memory controller 400 will be described as having circuit-configuring memory, with circuit information stored in the flash memory 302 being loaded to the circuit-configuring memory within the memory controller 400 to function as a circuit, though this is not illustrated in FIG. 3.

The load device 303 is connected to the flash memory 302, the CPU 305, and the memory controller 400. Upon receiving an activation instruction from the CPU 305, the load device 303 reads circuit information out from the flash memory 302, and loads the read circuit information into the circuit-configuring memory provided within the memory controller 400. Note that the timing of accepting the activation instruction from the CPU 305 is, for example, the timing at which the power is turned on to the adapter 300, or the like.

Next, description will be made regarding the channel controller 304, CPU 305, and memory controller 400. In the following, first, description will be made regarding the connection relation of the circuits within the adapter 300, following which the data relay processing which the circuits perform cooperatively will be described. For the data relay processing which the circuits perform cooperatively, description will be made regarding a case in which the host server 100 reads out information from the storage system 200, and a case in which the host server 100 writes information to the storage system 200.

The connection relation of the circuits within the adapter 300 will be described with reference to FIG. 3. As illustrated in FIG. 3, the channel controller 304 is connected to the host server 100, memory controller 400, and CPU 305. The CPU 305 is connected to the channel controller 304, load device 303, and memory controller 400. Upon the power being turned on to the adapter 300, the CPU 305 sends an activation instruction to the load device 303, and causes the load device 303 to load circuits to the circuit-configuring memory within the memory controller 400.

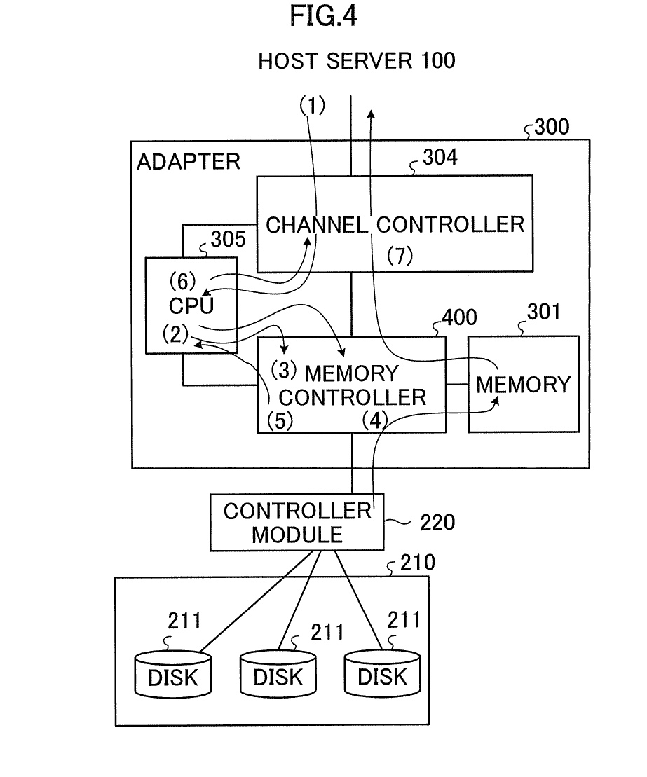

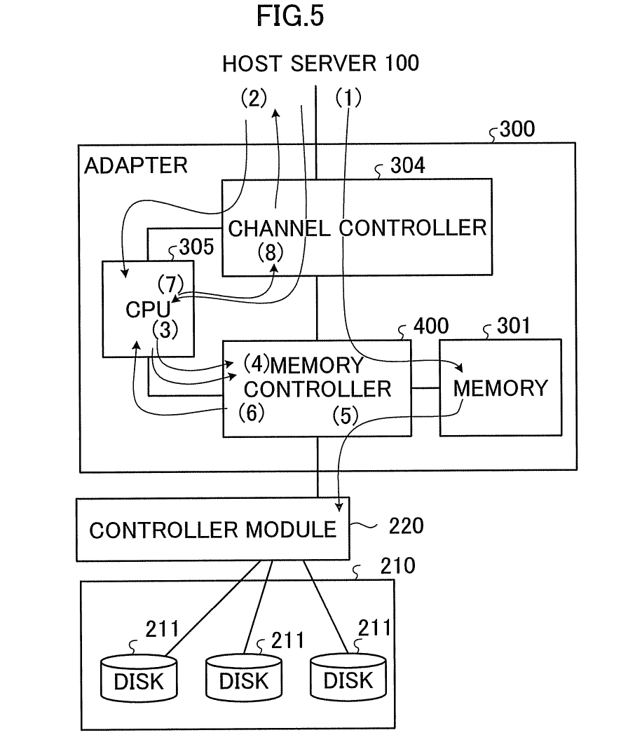

The memory controller 400 is connected to the memory 301, channel controller 304, CPU 305, load device 303, and controller module 220, and has circuit-configuring memory though not illustrated in FIG. 3. The memory controller 400 causes the load device 303 to load the circuit information to the circuit-configuring memory, thereby forming the circuits within the memory controller 400. Note that processing performed by the memory controller 400 is executed by the circuits, formed by circuit information being loaded to the circuit-configuring memory, operating cooperatively. Detailed description of the memory controller 400 will be described later, and accordingly will be omitted from the description made with reference to FIGS. 4 and 5.

Data relay processing which the channel controller 304, CPU 305, and memory controller 400 perform cooperatively will be described with reference to FIGS. 4 and 5. Note that the controller module 220, disk enclosure 210, and disks 211 are also illustrated in FIGS. 4 and 5 to facilitate description. Note that FIG. 4 is a diagram for describing the adapter according to the first embodiment at the time of read processing, and FIG. 5 is a diagram for describing the adapter according to the first embodiment at the time of write processing.

A case of the host server 100 reading information from the storage system 200, i.e., a case of host readout, will be described with reference to FIG. 4. That is to say, the processing performed within the adapter 300 from the point that the host server 100 gives a read instruction for reading data to the adapter 300, till the host server 100 receives the data from the adapter 300, will be described.

As indicated by (1) in FIG. 4, upon receiving a read instruction (READ command) from the host server 100, the channel controller 304 transmits a disk read instruction, to read data from the disks 211, to the CPU 305. As indicated by (2) and (3) in FIG. 4, the CPU 305 transmits the disk read instruction to the memory controller 400. As indicated by (4) in FIG. 4, the memory controller 400 writes the data read out from the disks 211 to the memory 301. Specifically, the memory controller 400 sends the disk read instruction to the controller module 220, and the controller module 220 reads the data out from the disks 211. Subsequently, the memory controller 400 receives the data from the controller module 220, and writes the received data to the memory 301.

As indicated by (5) in FIG. 4, the memory controller 400 sends a disk read end notification, to the effect that reading from the disks 211 has ended, to the CPU 305. As indicated by (6) in FIG. 4, the CPU 305 sends a memory read instruction, which is an instruction to the host server 100, to the effect to read from the memory 301 the data that has been read out.

As indicated by (7) in FIG. 4, the channel controller 304 obtains the data to be read out that has been written to the memory, and sends this to the host server 100. Specifically, the channel controller 304 transmits a memory read instruction to the memory controller 400. Subsequently, the memory controller 400 reads out from the memory 301 the data identified by the received memory read instruction, and transmits the data that has been read out to the channel controller 304. The channel controller 304 sends the data received form the memory controller 400 to the host server 100, and transmits a read end notification to the effect that reading has ended.

Next, a case of the host server 100 writing information to the storage system 200, i.e., a case of host writing, will be described with reference to FIG. 5. That is to say, the processing performed within the adapter 300 from the point that the host server 100 gives a write instruction for reading data to the adapter 300, till the host server 100 receives a write end notification from the adapter 300, will be described.

As indicated by (1) in FIG. 5, upon receiving data and a write instruction from the host server 100, the channel controller 304 stores the received data in the memory 301. That is to say, the channel controller 304 transmits the received data, and a memory write instruction which is an instruction to write the data to the memory 301, to the memory controller 400, and the memory controller 400 writes the received data to the memory 301.

As indicated by (2) in FIG. 5, the channel controller 304 transmits a disk write instruction (WRITE command) to write the data to the disks 211 to the CPU 305. As indicated by (3) and (4) in FIG. 5, the CPU 305 transmits the disk write instruction to the memory controller 400.

As indicated by (5) in FIG. 5, the memory controller 400 reads out the data written to the memory 301, transmits the read data and the disk write instruction to the controller module 220, and subsequently the controller module 220 writes the data to the disks 211.

As indicated by (6) in FIG. 5, the memory controller 400 transmits a disk write end notification to the CPU 305, to the effect that writing to the disks 211 has ended. As indicated by (7) in FIG. 5, the CPU 305 transmits a write end notification instruction to the channel controller 304, to transmit information to the host server 100 to the effect that the writing has ended. As indicated by (8) in FIG. 5, the channel controller 304 transmits the write end notification to the host server 100 to the effect that the writing has ended.

### (Construction of the Memory Controller)

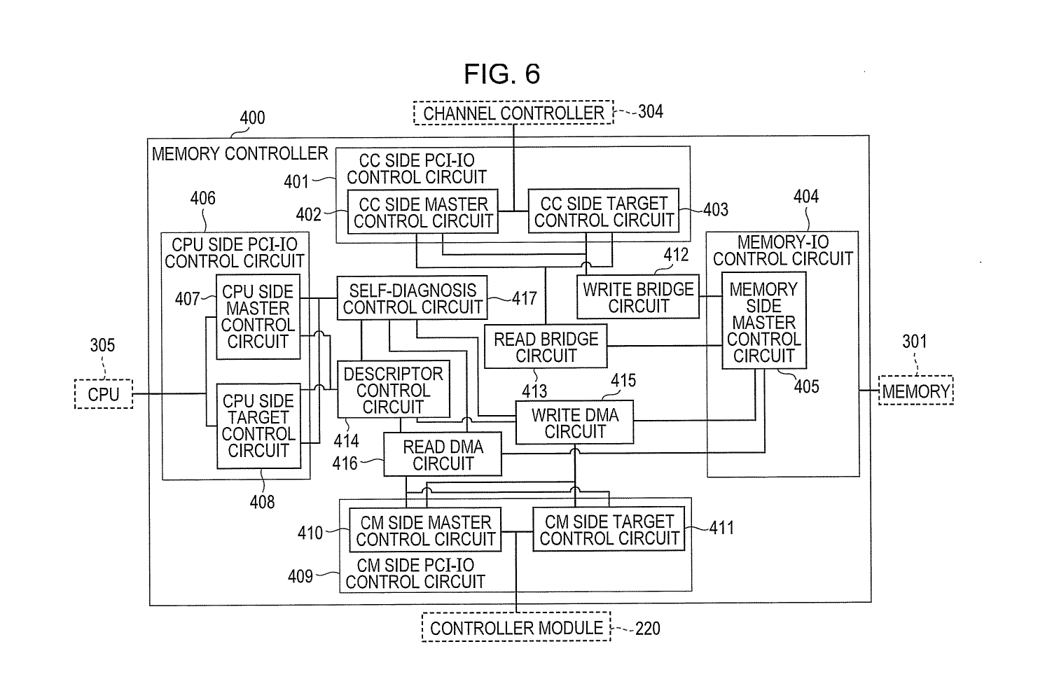

Next, each of the circuits within the memory controller 400 according to the first embodiment will be briefly described with reference to FIG. 6. Note that FIG. 6 is a block diagram for describing circuits within the memory controller according to the first embodiment.

As illustrated in FIG. 6, the memory controller 400 includes a CC side PCI-IO control circuit 401, a memory-IO control circuit 404, a CPU side PCI-IO control circuit 406, and a CM side PCI-IO control circuit 409. The memory controller 400 also includes a write bridge circuit 412, a read bridge circuit 413, a descriptor control circuit 414, a self-diagnosis control circuit 417, a write DMA circuit 415, and a read DMA circuit 416.

Note that with the first embodiment, description will be made regarding an arrangement wherein, of the circuits within the memory controller 400, the write DMA circuit 415 and read DMA circuit 416 are realized on the programmable device, and the write DMA circuit 415 and read DMA circuit 416 are to execute self-diagnosis processing.

In the following, first the connection relation of the parts within the memory controller 400 will be briefly described, following which the flows which each part generates will be described in brief.

The connection relation of the parts within the memory controller 400 will be briefly described. As illustrated in FIG. 6, the CC side PCI-IO control circuit 401 has a CC side master control circuit 402 and a CC side target control circuit 403, with the CC side master control circuit 402 and CC side target control circuit 403 connected to the channel controller 304, write bridge circuit 412, and read bridge circuit 413.

The CC side master control circuit 402 and CC side target control circuit 403 operate cooperatively to relay exchange of data between the channel controller 304 and the memory controller 400.

The memory-IO control circuit 404 has a memory side master control circuit 405, with the memory side master control circuit 405 connected to the memory 301, write bridge circuit 412, read bridge circuit 413, write DMA circuit 415, and read DMA circuit 416. The memory side master control circuit 405 writes data to the memory 301, and also reads out data from the memory 301.

The CPU side PCI-IO control circuit 406 includes a CPU side master control circuit 407 and a CPU side target control circuit 408. The CPU side master control circuit 407 and CPU side target control circuit 408 are connected to the CPU 305, descriptor control circuit 414, and self-diagnosis control circuit 417.

The CPU side master control circuit 407 and CPU side target control circuit 408 operate cooperatively to relay exchange of data between the CPU 305 and the memory controller 400.

The CM side PCI-IO control circuit 409 includes a CM side master control circuit 410 and CM side target control circuit 411, with the CM side master control circuit 410 and CM side target control circuit 411 connected to the read DMA circuit 416 and write DMA circuit 415.

The CM side master control circuit 410 and CM side target control circuit 411 operate cooperatively to relay exchange of data between the controller module 220 and the memory controller 400.

The write bridge circuit 412 and read bridge circuit 413 are connected to the CC side master control circuit 402, CC side target control circuit 403, and memory side master control circuit 405, and relay exchange of data and instructions between the CC side master control circuit 402 and CC side target control circuit 403, and the memory side master control circuit 405.

The descriptor control circuit 414 is connected to the CPU side master control circuit 407, CPU side target control circuit 408, self-diagnosis control circuit 417, write DMA circuit 415, and read DMA circuit 416. The descriptor control circuit 414 receives disk write instructions and disk read instructions from the CPU side target control circuit 408, and transmits the received disk write instructions to the write DMA circuit 415 and disk read instructions to the read DMA circuit 416.

Upon receiving a disk write end notification from the write DMA circuit 415, the descriptor control circuit 414 transmits the received disk write end notification to the CPU side master control circuit 407. Also, upon receiving a disk read end notification from the read DMA circuit 416, the descriptor control circuit 414 transmits the received disk write end notification to the CPU side master control circuit 407.

Note that upon receiving a later-described diagnosis mode start announcement from the self-diagnosis control circuit 417, the descriptor control circuit 414 causes the write DMA circuit 415 and read DMA circuit 416 to keep from executing new processing other than the processing currently being processed. Details of the processing of the descriptor control circuit 414 following reception of the diagnosis mode start announcement will be described later, so description thereof will be omitted here.

The write DMA circuit 415 and read DMA circuit 416 are connected to the memory side master control circuit 405, CM side master control circuit 410, CM side target control circuit 411, descriptor control circuit 414, and self-diagnosis control circuit 417. Also, the write DMA circuit 415 and read DMA circuit 416 execute DMA (Direct Memory Access) wherein data relay processing is performed without going through the CPU 305. Specifically, disk write instructions and disk read instructions received from the descriptor control circuit 414 are used to perform data relay processing.

Also, upon receiving a diagnosis mode start announcement from the self-diagnosis control circuit 417, the write DMA circuit 415 and read DMA circuit 416 start self-diagnosis processing at the timing at which the processing currently being processed ends. Also, upon completion of the self-diagnosis processing, the write DMA circuit 415 and read DMA circuit 416 transmit a diagnosis end notification to the self-diagnosis control circuit 417. Details of the processing performed by the write DMA circuit 415 and read DMA circuit 416 after having received the diagnosis mode start announcement will be descried later, so description thereof will be omitted here.

Next, the flows generated by each of the parts in the memory controller 400 will be described in brief. First, a case wherein the CC side target control circuit 403 has received a memory read instruction will be described. In this case, processing is generated in the order of the CC side target control circuit 403, read bridge circuit 413, memory side master control circuit 405, read bridge circuit 413, and CC side master control circuit 402.

That is to say, upon receiving a memory read instruction from the channel controller 304, the CC side target control circuit 403 transmits the memory read instruction to the read bridge circuit 413. The read bridge circuit 413 transmits the memory read instruction received from the CC side target control circuit 403 to the memory side master control circuit 405. Subsequently, the memory side master control circuit 405 reads the data out from the memory 301 and transmits this to the read bridge circuit 413, and the read bridge circuit 413 transmits the data to the CC side master control circuit 402. The CC side master control circuit 402 then transmits the data to the channel controller 304.

Also, a case wherein the CC side target control circuit 403 has received data and a memory write instruction will be described. In this case, processing is generated in the order of the CC side target control circuit 403, write bridge circuit 412, and memory side master control circuit 405.

That is to say, upon receiving the data and the memory write instruction from the channel controller 304, the CC side target control circuit 403 transmits the received data and memory write instruction to the write bridge circuit 412. The write bridge circuit 412 transmits the data and memory write instruction that has been received from the CC side target control circuit 403 to the memory side master control circuit 405, and the memory side master control circuit 405 writes the received data to the memory 301.

Also, a case wherein the CPU side target control circuit 408 has received a disk read instruction will be described. In this case, processing is generated in the order of the CPU side target control circuit 408, descriptor control circuit 414, read DMA circuit 416, CM side master control circuit 410, and CM side target control circuit 411.

That is to say, upon receiving the disk read instruction from the CPU 305, the CPU side target control circuit 408 transmits the received disk read instruction to the descriptor control circuit 414. The descriptor control circuit 414 transmits the disk read instruction received from the CPU side target control circuit 408 to the read DMA circuit 416. Subsequently, the read DMA circuit 416 transmits the disk read instruction to the CM side master control circuit 410, and the CM side master control circuit 410 transmits the disk read instruction to the controller module 220. The CM side target control circuit 411 then receives a disk read end notification to the effect that reading from the disks 211 has ended, and the data, from the controller module 220, and transmits these to the read DMA circuit 416. The read DMA circuit 416 transmits the received data to the memory side master control circuit 405, and also transmits the disk read end notification to the descriptor control circuit 414. The memory side master control circuit 405 writes the received data to the memory 301, and the descriptor control circuit 414 transmits the disk read end notification to the CPU side master control circuit 407. Subsequently, the CPU side master control circuit 407 transmits the disk read end notification to the CPU 305.

Also, a case wherein the CPU side target control circuit 408 has received a disk write instruction will be described. In this case, processing is generated in the order of the CPU side target control circuit 408, descriptor control circuit 414, write DMA circuit 415, memory side master control circuit 405, and write DMA circuit 415. Subsequently, further processing is generated in the order of the CM side master control circuit 410, CM side target control circuit 411, write DMA circuit 415, descriptor control circuit 414, and CPU side master control circuit 407.

That is to say, upon receiving the disk write instruction from the CPU 305, the CPU side target control circuit 408 transmits the received disk write instruction to the descriptor control circuit 414. The descriptor control circuit 414 transmits the disk write instruction received from the CPU side target control circuit 408 to the write DMA circuit 415. The write DMA circuit 415 transmits the disk write instruction to the memory side master control circuit 405, and the memory side master control circuit 405 reads out the data to be written from the memory 301 and transmits this to the write DMA circuit 415. Subsequently, the write DMA circuit 415 transmits the received data to the CM side master control circuit 410, and the CM side master control circuit 410 transmits the received data to the controller module 220. Subsequently, the CM side target control circuit 411 receives a disk write end notification to the effect that writing from the disks 211 has ended, and transmits the disk write end notification to the write DMA circuit 415. The write DMA circuit 415 then transmits the disk write end notification to the descriptor control circuit 414, and the descriptor control circuit 414 transmits the disk write end notification to the CPU side master control circuit 407. The CPU side master control circuit 407 transmits the disk write end notification to the CPU 305.

Upstream circuits will be described with the flows which the above-described processing generates in mode. An upstream circuit is a processing circuit which performs processing upstream of any of the processing executed at the processing circuits which execute self-diagnosis processing, and controls starting of processing at the processing circuits.

For example, in the first embodiment, the write DMA circuit 415 and read DMA circuit 416 execute self-diagnosis processing. The write DMA circuit 415 and read DMA circuit 416 perform data relay processing (data relay processing performed by the write DMA circuit 415 is referred to as “write DMA”, and data relay processing performed by the read DMA circuit 416 is referred to as “read DMA”), using the disk write instruction and disk read instruction sent from the descriptor control circuit 414. That is to say, the descriptor control circuit 414 sending a disk write instruction or disk read instruction starts processing at the write DMA circuit 415 or read DMA circuit 416. Thus, the descriptor control circuit 414 is an upstream circuit as to the write DMA circuit 415 and read DMA circuit 416.

The self-diagnosis control circuit 417 is connected to the descriptor control circuit 414, write DMA circuit 415, and read DMA circuit 416. At the timing for self-diagnosis processing, the self-diagnosis control circuit 417 transmits a diagnosis mode start announcement, which is information to the effect that processing relating to self-diagnosis is to be started, to the circuits related to the self-diagnosis processing. That is to say, the self-diagnosis control circuit 417 transmits a start information to the effect that self-diagnosis processing is to be stated. Note that description regarding the processing at the circuits which have received the diagnosis mode start announcement will be described later, and omitted here.

Specifically, the self-diagnosis control circuit 417 transmits the diagnosis mode start announcement to the circuits which execute the self-diagnosis processing, and upstream circuits. Note that the timing at which the self-diagnosis processing is performed is, for example, a predetermined timing determined by the manufacturer of the adapter 300, or each time an instruction to that end is received form the host server 100, or the like.

For example, the self-diagnosis control circuit 417 transmits the diagnosis mode start announcement to the write DMA circuit 415 and read DMA circuit 416 which are the circuits to execute the self-diagnosis processing, and also transmits the diagnosis mode start announcement to the descriptor control circuit 414 which is the upstream circuit. Details of the flow of self-diagnosis processing will be described later, so description will be omitted here.

Also, upon receiving a diagnosis end notification for all circuits which are to perform the self-diagnosis processing, the self-diagnosis control circuit 417 transmits a diagnosis mode end notification, and transmits a disk read end notification and disk write end notification. Note that a diagnosis end notification is information to the effect that diagnosis has ended, and will be described as including diagnosis results.

The point at which the diagnosis mode end notification is to be transmitted will be described. For example, upon receiving a diagnosis end notification from all circuits which are to perform self-diagnosis processing, the self-diagnosis control circuit 417 transmits the diagnosis mode end notification to the upstream circuit. As a specific example, upon receiving a diagnosis end notification from the write DMA circuit 415 and read DMA circuit 416, the self-diagnosis control circuit 417 transmits a diagnosis node end notification to the descriptor control circuit 414.

The self-diagnosis control circuit 417 transmits diagnosis results to the host server 100, controller module 220, CPU 305, and so forth, for example, each time a diagnosis end notification is received, or each time an error is included in a diagnosis end notification, or the like. The self-diagnosis control circuit 417 uses a dedicated interrupt signal or an MSI (Message Signaled Interrupt) to transmit the diagnosis results. Note that an MSI is for transmitting messages via the master control circuits.

Also, an arrangement may be made wherein the self-diagnosis control circuit 417 transmits the diagnosis results only in the vent that an error is included in a diagnosis result, and at this time transmits only information to the effect that an error is included without transmitting detailed contents of the error, for example. Also, an arrangement may be made wherein, for example, the self-diagnosis control circuit 417 has a register and stores errors in the register, with the CPU 305, controller module 220, or the like, which have received the diagnosis results accessing the register of the self-diagnosis control circuit 417 so as to read out the detailed contents of the error from the self-diagnosis control circuit 417.

The point at which a disk read end notification or a disk write end notification is to be transmitted will be described. Upon receiving a diagnosis end notification from all circuits which are to perform self-diagnosis processing, the self-diagnosis control circuit 417 transmits a disk read end notification or disk write end notification to the CPU side master control circuit 407, instead of the descriptor control circuit 414.

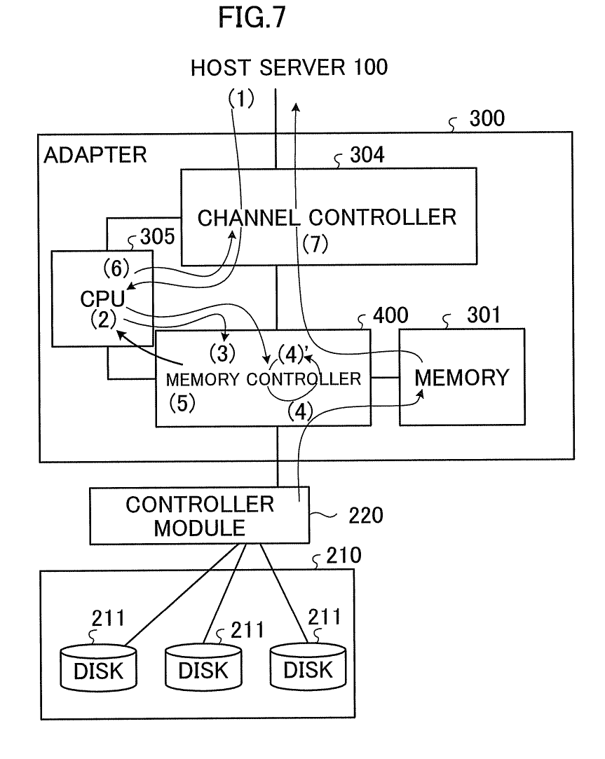

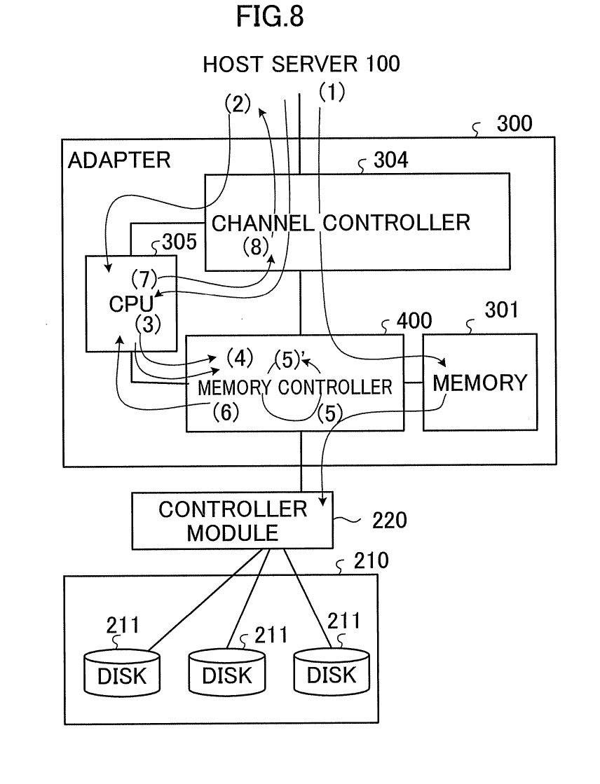

Consequently, as indicated by (4)′ in FIG. 7 and (5)′ in FIG. 8, at the memory controller 400, the write DMA circuit 415 and read DMA circuit 416 perform self-diagnosis processing before the disk read end notification ((7) in FIG. 7) and disk write end notification ((8) in FIG. 8) are transmitted. That is to say, the circuits which perform the self-diagnosis processing start their self-diagnosis processing at the timing at which the processing currently being processed ends, and performs the self-diagnosis processing at the timing before transmission of the disk read end notification ((7) in FIG. 7) and disk write end notification ((8) in FIG. 8). FIG. 7 is a diagram for describing timing at which self-diagnosis processing is executed during read processing in the first embodiment, and FIG. 8 is a diagram for describing timing at which self-diagnosis processing is executed during write processing in the first embodiment.

### (Processing Performed at Each of the Circuits)

Also, the processing performed at each of the circuits which have received a diagnosis mode start announcement will be described. In the following, first description will be made regarding upstream circuits, followed by description regarding the circuits which perform the self-diagnosis processing.

First, the upstream circuit will be described. Upon receiving a diagnosis mode start announcement, the upstream circuit performs processing such that the circuits which are to perform the self-diagnosis processing do not start new processing after they have ended the processing currently being processed, until the self-diagnosis processing has ended.

Specifically, upon receiving a diagnosis mode start announcement, i.e., in the event that self-diagnosis processing is to be started, the upstream circuit performs processing such that no new processing occurs at the circuits which are to perform the self-diagnosis processing. For example, the upstream circuit performs retry response, which is to transmit information to the sender of an instruction to the effect to retry. The sender which has received a retry response will transmit the instruction to the upstream circuit again.

Further, the upstream circuit maintains the retry response until a diagnosis mode end notification which is information to the effect that the diagnosis mode will end is received from the self-diagnosis control circuit 417. Once the diagnosis mode end notification is received, the retry response is disengaged.

Also, the upstream circuit transmits information to the circuits which execute the self-diagnosis processing, to the effect that new processing is not to be started. For example, the descriptor control circuit 414 transmits disk write instructions and disk read instructions for the processing currently being performed to the write DMA circuit 415 and read DMA circuit 416, but thereafter transmits no new disk write instructions or disk read instructions. Also, the descriptor control circuit 414 transmits information to the write DMA circuit 415 and read DMA circuit 416 to the effect that no new processing will occur hereafter.

Next, the circuits which execute the self-diagnosis processing will be described. Upon receiving a diagnosis mode start announcement, a circuit which is to perform the self-diagnosis processing starts the self-diagnosis processing at the timing at which the processing current being processed ends. For example, upon receiving information to the effect that no new processing will be started from the descriptor control circuit 414, the write DMA circuit 415 and read DMA circuit 416 start self-diagnosis processing, and upon completion of the self-diagnosis processing, transmit a diagnosis end notification to the self-diagnosis control circuit 417.

### (Explanation of the Circuit Forming Processing in the Memory Controller)

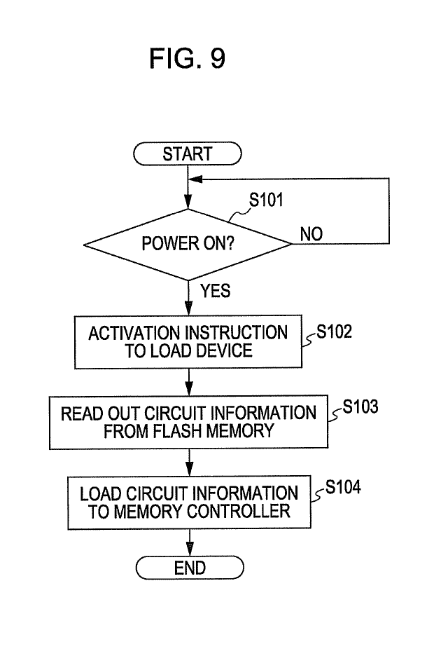

Next, the flow of processing in which the circuits are formed in the memory controller 400 according to the first embodiment will be described with reference to FIG. 9. FIG. 9 is a flowchart for describing the flow of processing in which the circuits are formed in the memory controller according to the first embodiment.

As illustrated in FIG. 9, upon the power being turned on to the adapter 300 (Yes in step S101), the CPU 305 transmits an activation instruction to the load device 303 (step S102). Upon receiving the activation instruction from the CPU 305, the load device 303 reads out circuit information from the flash memory 302 (step S103), and loads the circuit information which has been read out to the circuit-configuring memory provided within the memory controller 400 (step S104).

### (Explanation of the Self-Diagnosis Processing)

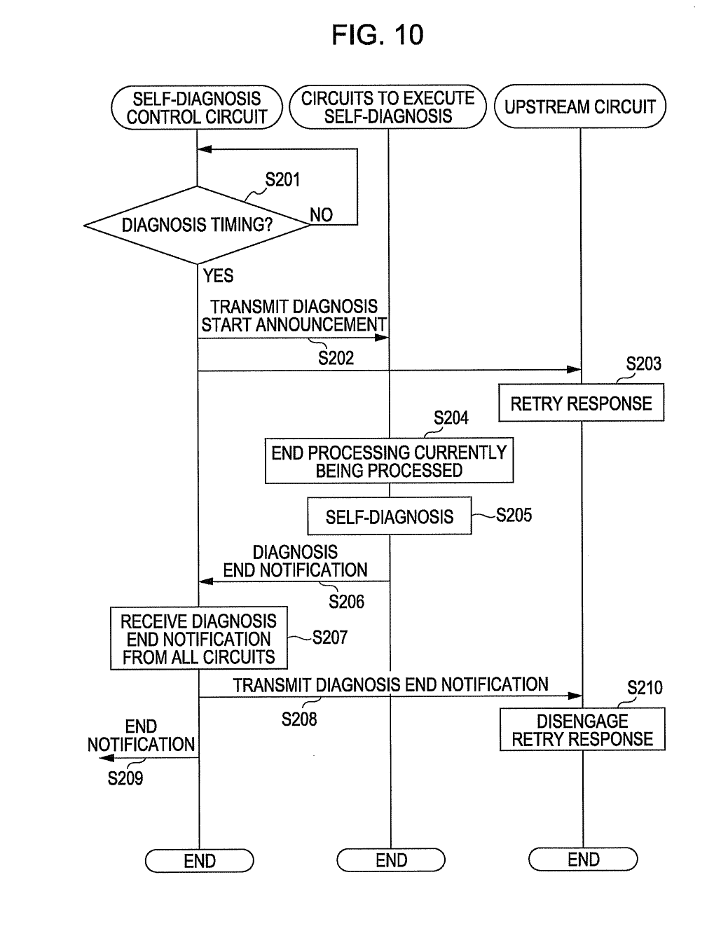

Next, an overview of the self-diagnosis processing performed within the memory controller 400 according to the first embodiment will be described with reference to FIG. 10. FIG. 10 is a sequence diagram for describing the overview of the flow of self-diagnosis processing performed within the memory controller according to the first embodiment.

As illustrated in FIG. 10, at the timing for performing self-diagnosis processing (Yes in step S201), the self-diagnosis control circuit 417 transmits a diagnosis mode start announcement (step S202). For example, the self-diagnosis control circuit 417 transmits this to the write DMA circuit 415, read DMA circuit 416, and descriptor control circuit 414.

Upon receiving the diagnosis mode start announcement, the upstream circuit performs retry response (step S203). That is to say, upon receiving an instruction from another circuit to the effect that new processing is to be started, the descriptor control circuit 414 transmits an instruction to the sender to the effect to retry.

Also, upon receiving the diagnosis mode start announcement and ending the processing currently being processed (step S204), the circuits which perform the self-diagnosis processing each start their self-diagnosis processing (step S205). For example, the write DMA circuit 415 and read DMA circuit 416 each start self-diagnosis processing. Upon the self-diagnosis ending, the write DMA circuit 415 and read DMA circuit 416 each transmit a diagnosis end notification to the self-diagnosis control circuit 417 (step S206).

Upon having received diagnosis end notifications from all of the circuits which perform self-diagnosis processing (step S207), i.e., upon completion of the self-diagnosis processing at the circuits which perform self-diagnosis processing, the self-diagnosis control circuit 417 transmits a diagnosis mode end notification to the upstream circuit (step S208). Also, the self-diagnosis control circuit 417 transmits information to the effect that the processing to be executed at the circuits which perform the self-diagnosis processing has ended, in lieu of the circuits (step S209). For example, the self-diagnosis control circuit 417 transmits a disk write end notification and disk read end notification.

Also, the self-diagnosis control circuit 417 transmits diagnosis results along with the disk write end notification and disk read end notification, following which the adapter 300 transmits the diagnosis results to the host server 100. Note that the present art is not restricted to this arrangement, and the diagnosis results do not have to be transmitted together.

Upon receiving the diagnosis mode end notification, the upstream circuit disengages the retry response (step S210).

### (Flow of the Self-Diagnosis Processing)

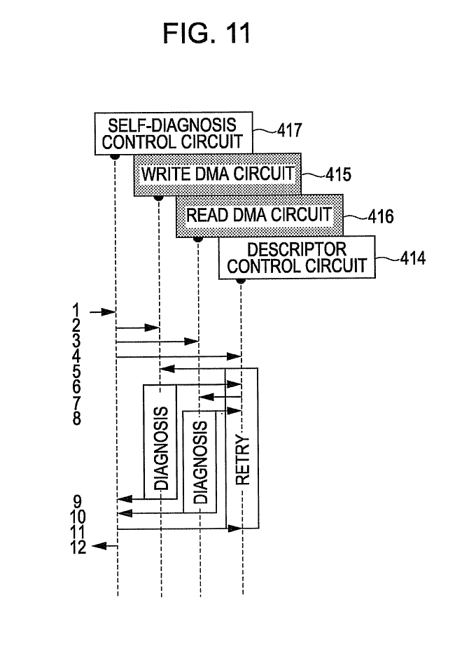

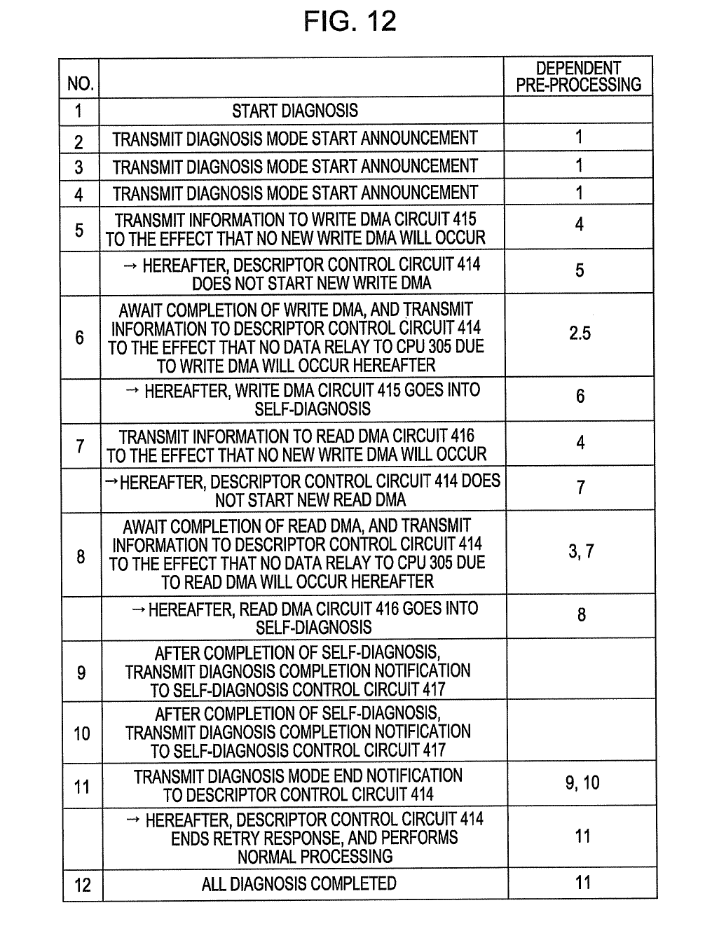

Next, the flow of processing of the descriptor control circuit 414, write DMA circuit 415, read DMA circuit 416, and self-diagnosis control circuit 417 will be further described with reference to FIGS. 11 and 12. FIGS. 11 and 12 are diagram for describing the flow of self-diagnosis processing performed within the memory controller according to the first embodiment. Note that the term “dependent pre-processing” in FIG. 12 means processing which has to be performed before the corresponding processing may be carried out.

As indicated by No. 1 in FIGS. 11 and 12, at the diagnosis processing start timing, the self-diagnosis control circuit 417 transmits a diagnosis mode start announcement to the descriptor control circuit 414, write DMA circuit 415, and read DMA circuit 416, as indicated by Nos. 2 through 4 in FIGS. 11 and 12.

As indicated by No. 5 in FIGS. 11 and 12, upon receiving the diagnosis mode start announcement, the descriptor control circuit 414 transmits information to the write DMA circuit 415 to the effect that no new write DMAs will occur hereafter. Also, the descriptor control circuit 414 does not start any new write DMAs hereafter.

That is to say, the descriptor control circuit 414 does not transmit new disk write instructions to the write DMA circuit 415, and as illustrated in FIG. 11, performs retry response. Note that a write DMA is processing performed at the write DMA circuit 415, and a read DMA is processing performed at the read DMA circuit 416.

As indicated by No. 6 in FIGS. 11 and 12, the write DMA circuit 415 awaits for the write DMA to end, and transmits information to the descriptor control circuit 414 to the effect that no new data relay to the CPU 305 will occur from a write DMA. That is to say, the write DMA circuit 415 transmits information to the effect that no write DMAs will be performed, and accordingly no data will be transmitted to the descriptor control circuit 414. The write DMA circuit 415 then starts self-diagnosis.

Also, as indicated by No. 7 in FIGS. 11 and 12, in the same way as with the write DMA circuit 415, the descriptor control circuit 414 also transmits information to the read DMA circuit 416 to the effect that no new read DMAs will occur hereafter, and does not start any new read DMAs hereafter. That is to say, the descriptor control circuit 414 does not transmit new disk read instructions to the read DMA circuit 416.

As indicated by No. 8 in FIGS. 11 and 12, the read DMA circuit 416 awaits for the read DMA to end, and transmits information to the descriptor control circuit 414 to the effect that no new data relay to the CPU 305 will occur from a read DMA. That is to say, the read DMA circuit 416 transmits information to the effect that no read DMAs will be performed, and accordingly no data will be transmitted to the descriptor control circuit 414. The read DMA circuit 416 then starts self-diagnosis processing.

As indicated by No. 9 in FIGS. 11 and 12, after starting self-diagnosis processing, upon completion of the self-diagnosis the write DMA circuit 415 transmits a diagnosis end notification to the self-diagnosis control circuit 417.

Also, as indicated by No. 10 in FIGS. 11 and 12, after starting self-diagnosis processing, upon completion of the self-diagnosis processing the read DMA circuit 416 transmits a diagnosis end notification to the self-diagnosis control circuit 417.

As indicated by No. 11 in FIGS. 11 and 12, upon the self-diagnosis processing of the write DMA circuit 415 and read DMA circuit 416 ending, the self-diagnosis control circuit 417 transmits a diagnosis mode end notification to the descriptor control circuit 414. Hereafter, the descriptor control circuit 414 ends the retry processing, and performs normal processing.

As indicated by No. 12 in FIGS. 11 and 12, the self-diagnosis processing ends.

### (Effects of the First Embodiment)

As described above, according to the first embodiment, an adapter 300 has multiple processing circuits, and upon processing to be performed at themselves ending, each processing circuit start self-diagnosis processing of itself. Consequently, according to the first embodiment, the diagnosis processing may be made in a short time. Specifically, each circuit diagnoses itself upon processing to be performed at each circuit ending, so the diagnosis processing may be performed in a short time.

For example, with the first embodiment, the circuit A may perform self-diagnosis processing parallel to the circuit B performing processing, unlike as with conventional techniques. Also, each of the processing circuits may start as suitable, without stopping processing of all of the processing circuits within the adapter 300.

Also, according to the first embodiment, in a case wherein an upstream circuit is further provided and the upstream circuit starts the self-diagnosis processing, processing is performed such that new processing does not occur at the processing circuits which are to start the self-diagnosis processing. Consequently, according to the first embodiment, according to the first embodiment, no new processing occurs at circuits to perform self-diagnosis processing, thereby enabling self-diagnosis processing to be performed. For example, the upstream circuit executes retry response, or freezes starting of new processing.

For example, a situation wherein an instruction to start new processing is transmitted to a circuit performing self-diagnosis processing, and the self-diagnosis processing fails, may be prevented. Also, a situation may be prevented wherein instructions received by a circuit performing self-diagnosis processing may not be handled as a result of receiving new instructions while performing the self-diagnosis processing. For example, a situation may be prevented wherein a circuit performing self-diagnosis processing receives an instruction but may not store the instruction appropriately and looses it, but the sender of the instruction considers the instruction to have been transmitted and time passes in this state.

Also, according to the first embodiment, diagnosis results are transmitted along with disk write end notifications and disk read end notifications, so the reliability of data relay processing may be improved. That is to say, in the event that an error is included in the diagnosis results, the host server 100 may know that an error is included in the data read or data write results instructed to the adapter 300, and that errors may occur hereafter.

### 2. Second Embodiment

Now, while a case has been described so far regarding the write DMA circuit 415 and read DMA circuit 416 performing self-diagnosis processing, the present art is not restricted to this arrangement. Accordingly, with a second embodiment, a case wherein the descriptor control circuit 414 also performs self-diagnosis processing in addition to the write DMA circuit 415 and read DMA circuit 416 will be described.

That is to say, with the second embodiment, description will be made regarding an arrangement wherein, of the circuits within the memory controller 400, the write DMA circuit 415, read DMA circuit 416, and descriptor control circuit 414 are realized on the programmable device, and perform self-diagnosis processing. Note that in the following, points which are the same as with the first embodiment will be either described only briefly or omitted from the description.

With the second embodiment, the CPU side target control circuit 408 serves as the upstream circuit of the write DMA circuit 415, read DMA circuit 416, and descriptor control circuit 414, as will be described below.

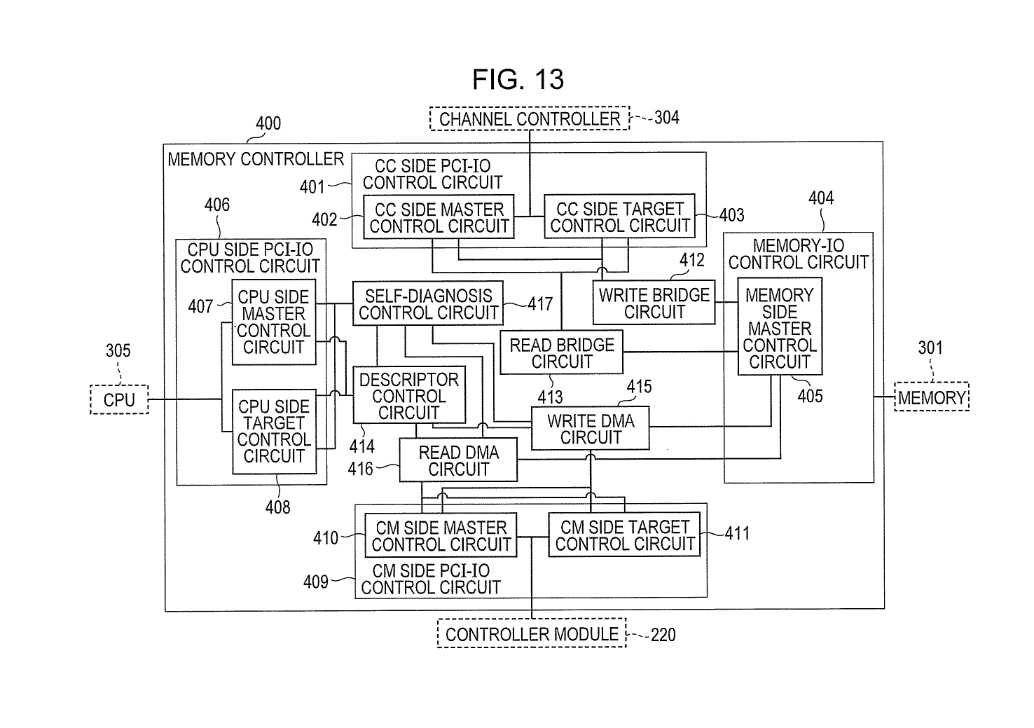

As illustrated in FIG. 13, with the second embodiment, in addition to be connected to the descriptor control circuit 414, write DMA circuit 415, and read DMA circuit 416, the self-diagnosis control circuit 417 is also connected to the CPU side target control circuit 408. FIG. 13 is a block diagram for describing the circuits within the memory controller according to the second embodiment.

The upstream circuit in the second embodiment will be described. The CPU side target control circuit 408 serves as the upstream circuit in the second embodiment. The reason is that the descriptor control circuit 414 receives disk write instructions and disk read instructions from the CPU side target control circuit 408, and performs the processing.

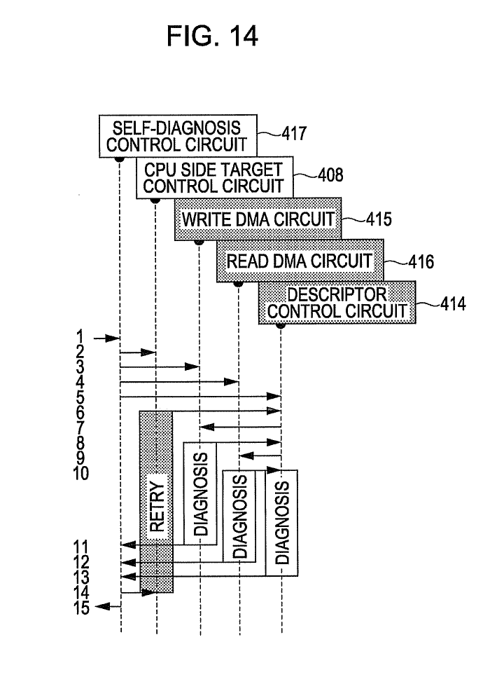

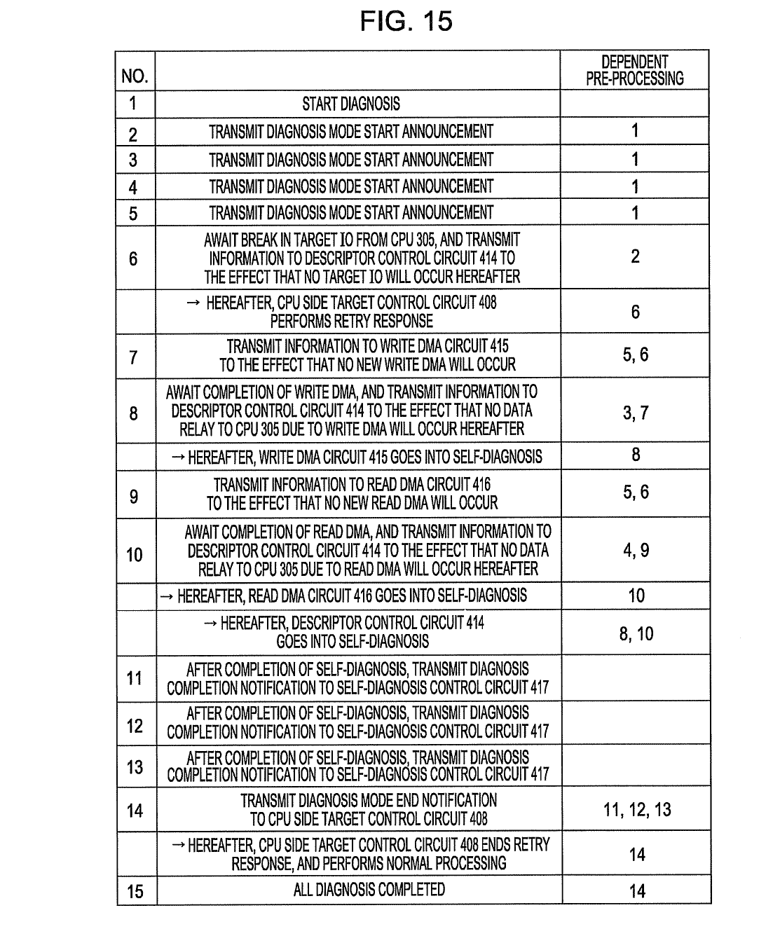

As indicated by No. 2 in FIGS. 14 and 15, with the second embodiment the self-diagnosis control circuit 417 transmits a diagnosis mode start announcement to not only the descriptor control circuit 414, write DMA circuit 415, and read DMA circuit 416, but also the CPU side target control circuit 408. FIGS. 14 and 15 are diagrams for describing the flow of self-diagnosis processing executed within the memory controller 400 according to the second embodiment.

Note that Nos. 3 through 5 in FIGS. 14 and 15 correspond to Nos. 2 through 4 in FIGS. 11 and 12, Nos. 7 through 10 in FIGS. 14 and 15 correspond to Nos. 5 through 8 in FIGS. 11 and 12, and Nos. 11 and 12 in FIGS. 14 and 15 correspond to Nos. 9 and 10 in FIGS. 11 and 12.

As indicated by No. 6 in FIGS. 14 and 15, the CPU side target control circuit 408 awaits for the target 10 from the CPU 305 to break, and transmits information to the descriptor control circuit 414 to the effect that no target 10 will occur hereafter. Note that an example of a target IO from the CPU 305 is a disk write instruction or disk read instruction. The CPU side target control circuit 408 then performs retry response. That is to say, even in the event that a disk write instruction or disk read instruction is received, the CPU side target control circuit 408 does not send the disk write instruction or disk read instruction to the descriptor control circuit 414 downstream. Consequently, no new processing occurs at the descriptor control circuit 414, write DMA circuit 415, or read DMA circuit 416.

Now, description will be made regarding the point that it is sufficient for the CPU side target control circuit 408 alone to perform retry response. The descriptor control circuit 414 receives disk write instructions and disk read instructions from the CPU side target control circuit 408 and performs processing. As a result, if the CPU side target control circuit 408 does not transmit any new disk write instructions or disk read instructions, no new processing will occur at the descriptor control circuit 414. If the descriptor control circuit 414 does not receive any new disk write instructions or disk read instructions, no new disk write instructions or disk read instructions will be transmitted to the write DMA circuit 415 or read DMA circuit 416, and no new processing will be started at the write DMA circuit 415 or read DMA circuit 416. That is to say, as long as the CPU side target control circuit 408 performs retry response, this means that the circuit farthest upstream from the write DMA circuit 415 and read DMA circuit 416 is performing retry response, and accordingly no new processing is started at the circuits downstream.

Subsequently, as indicated by No. 10 in FIGS. 14 and 15, upon information being transmitted to the effect that no data relay from the write DMA circuit 415 and read DMA circuit 416 to the CPU 305 will occur, the descriptor control circuit 414 starts self-diagnosis processing.

As indicated by No. 13 in FIGS. 14 and 15, upon completion of self-diagnosis processing, the descriptor control circuit 414 transmits a diagnosis end notification to the self-diagnosis control circuit 417.

As indicated by No. 14 in FIGS. 14 and 15, upon self-diagnosis processing of not only the write DMA circuit 415 and read DMA circuit 416 but also the descriptor control circuit 414 ending, the self-diagnosis control circuit 417 transmits a diagnosis mode end notification to the CPU side target control circuit 408. Hereafter, the CPU side target control circuit 408 ends the retry response and performs normal processing.

As indicated by No. 15 in FIGS. 14 and 15, diagnosis processing ends.

### (Effects of the Second Embodiment)

As described above, according to the second embodiment, the descriptor control circuit 414 is also the object of performing self-diagnosis processing, so the number of circuits performing self-diagnosis processing may be increased as compared with the first embodiment.

### 3. Third embodiment

Now, while an arrangement has been described in the second embodiment with regard to a case wherein, in addition to the write DMA circuit 415 and read DMA circuit 416, the descriptor control circuit 414 also performs self-diagnosis processing, the present art is not restricted to this arrangement. For example, an arrangement may be made wherein all circuits within the memory controller 400 which may perform self-diagnosis processing do so.

That is to say, with the third embodiment, a case will be described wherein all circuits within the memory controller 400 are realized on the programmable device. Accordingly, with the third embodiment, a case will be described wherein all circuits of the memory controller 400 other than the upstream circuits perform self-diagnosis processing.

Now, with the third embodiment, except for the processing circuits to serve as triggers for processing executed at other circuits, all other processing circuits within the memory controller 400 perform self-diagnosis processing. That is to say, by assigning the processing circuits which serve as triggers for processing executed at other circuits as upstream circuits, self-diagnosis processing may be performed at all other circuits.

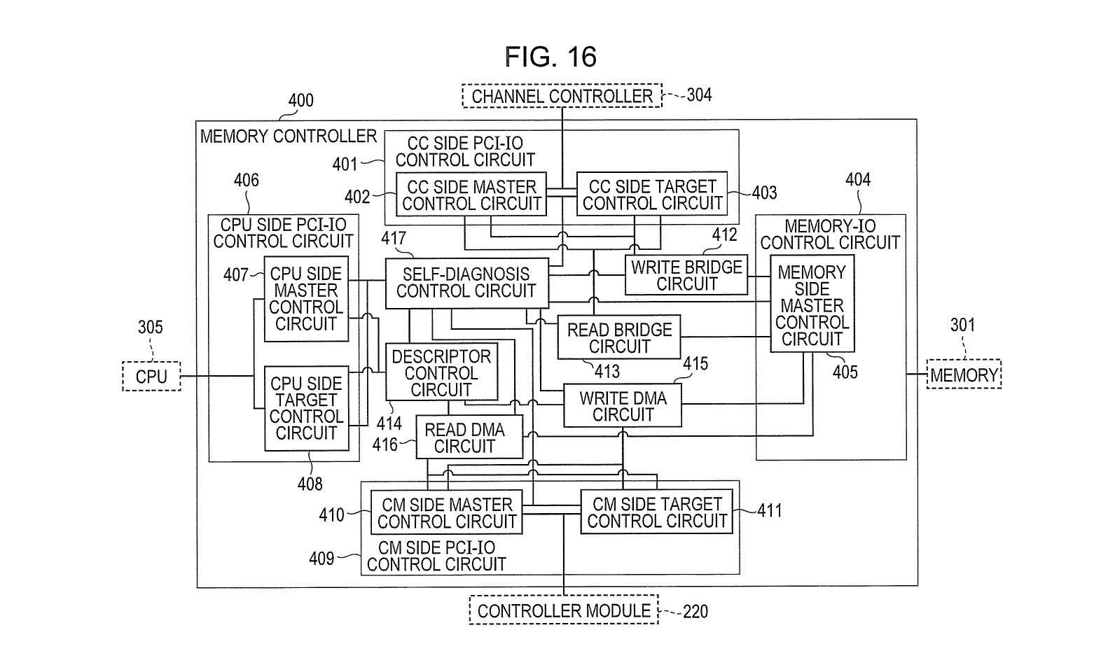

Specifically, with the third embodiment, the circuits which accept instructions of processing units external from the memory controller 400 serve as the upstream circuits. As illustrated in FIG. 16, processing units outside of the memory controller 400 are the channel controller 304, CPU 305, and controller module 220. Accordingly, the upstream circuits in the third embodiment will be the CC side target control circuit 403 which receives instructions and data transmitted from the channel controller 304, the CPU side target control circuit 408 which receives instructions and data transmitted from the CPU 305, and the CM side target control circuit 411 which receives data transmitted from the controller module 220.

As illustrated in FIG. 16, the self-diagnosis control circuit 417 is connected to all circuits within the memory controller 400. Note that FIG. 16 is a block diagram for describing the circuits within the memory controller 400 according to the third embodiment.

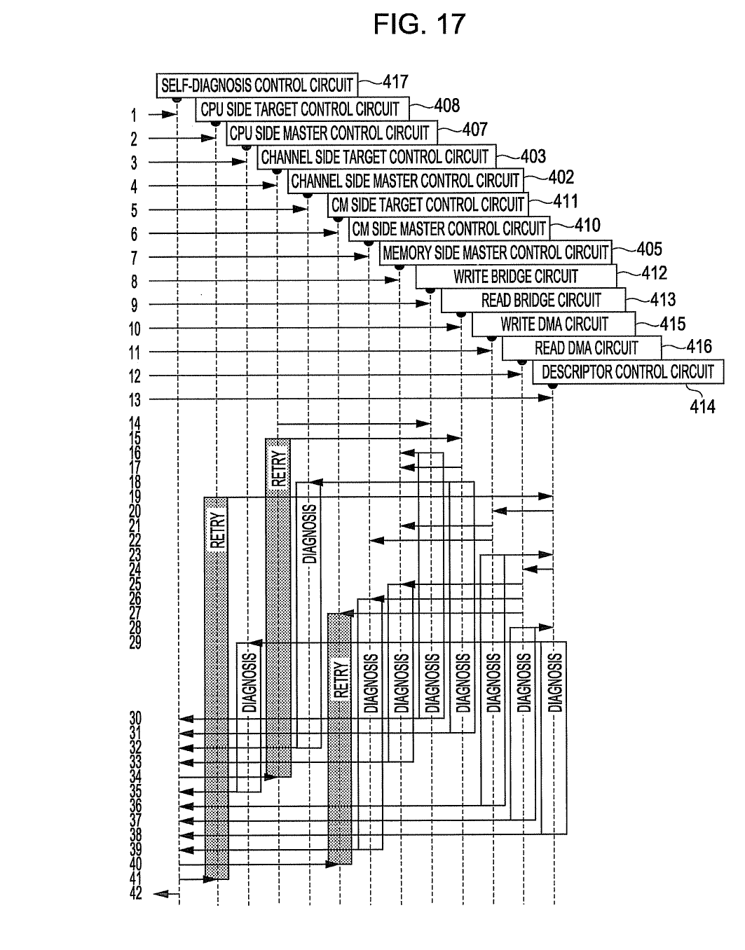

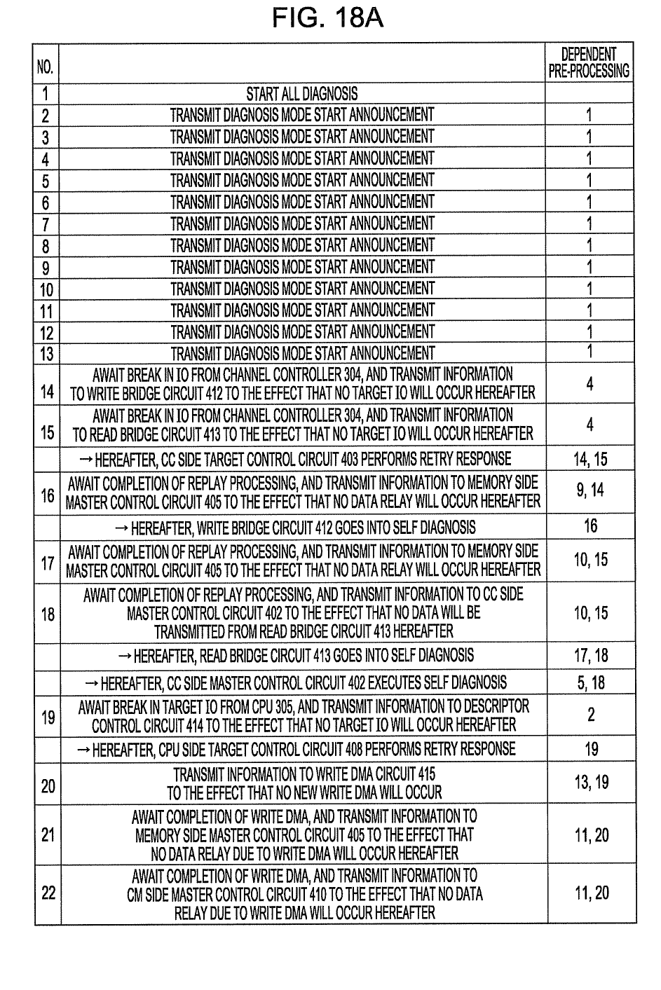

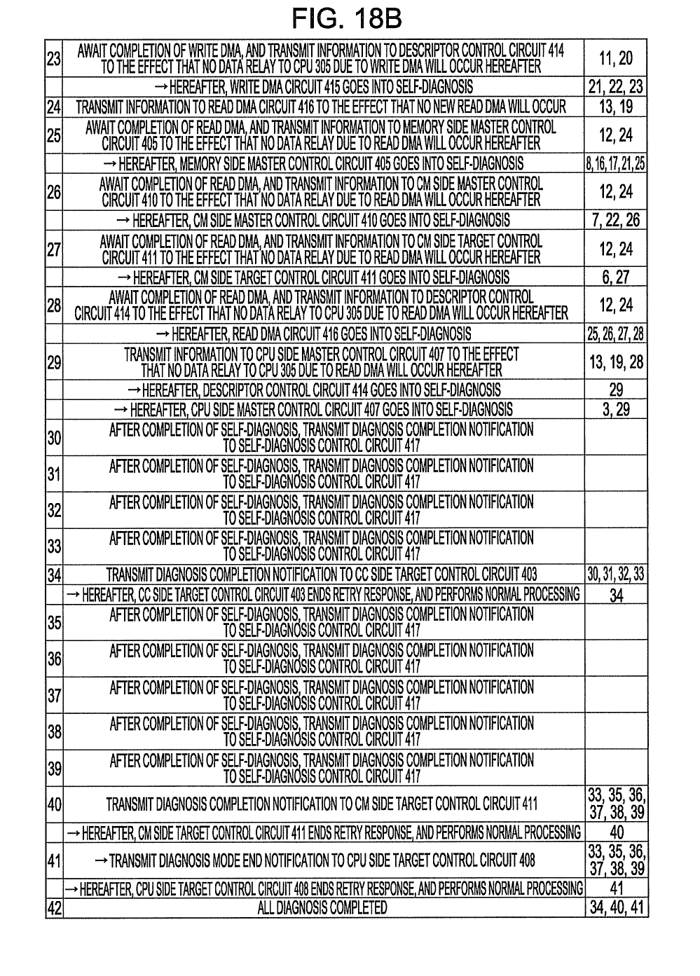

In the third embodiment, as indicated by No. 1 in FIGS. 17 and 18A, at the diagnosis processing start timing, the self-diagnosis control circuit 417 transmits a diagnosis mode start announcement to all circuits within the memory controller 400, as indicated by Nos. 2 through 13 in FIGS. 17 and 18A. FIG. 17 is a diagram for describing the flow of self-diagnosis processing performed within the memory controller according to the third embodiment. FIGS. 18A and 18B are diagrams for describing the flow of self-diagnosis processing performed within the memory controller according to the third embodiment.

As indicated by Nos. 14 and 15 in FIGS. 17 and 18A, upon receiving the diagnosis mode start announcement, the CC side target control circuit 403 awaits for the target IO from the channel controller 304 to break. Upon the target 10 breaking, the CC side target control circuit 403 transmits information to the write bridge circuit 412 and read bridge circuit 413 to the effect that no target IOs will occur hereafter. Note that examples of target IOs from the channel controller 304 here include memory write instructions and memory read instructions.

Also, the CC side target control circuit 403 performs retry response. That is to say, even if the CC side target control circuit 403 receives new memory write instructions or memory read instructions, the CC side target control circuit 403 does not send these to the write bridge circuit 412 and read bridge circuit 413 downstream, and accordingly does not allow new processing to occur.

Also, as indicated by No. 16 in FIGS. 17 and 18A, upon receiving the diagnosis mode start announcement, the write bridge circuit 412 awaits for the relay processing currently being processed to end, and transmits information to the memory side master control circuit 405 to the effect that no new data relay will occur hereafter. No new processing will occur at the write bridge circuit 412 hereafter, so the write bridge circuit 412 starts self-diagnosis processing.

Also, as indicated by No. 17 in FIGS. 17 and 18A, upon receiving the diagnosis mode start announcement, the read bridge circuit 413 awaits for the relay processing currently being processed to end, and transmits information to the memory side master control circuit 405 to the effect that no new data relay will occur hereafter.

As indicated by No. 18 in FIGS. 17 and 18A, the read bridge circuit 413 awaits for the relay processing to end, and transmits information to the CC side master control circuit 402 to the effect that no new data relay will be transmitted from the read bridge circuit 413 hereafter. The read bridge circuit 413 then performs self-diagnosis processing. Also, in the same way, no new processing will occur at the CC side master control circuit 402 hereafter, so the CC side master control circuit 402 starts self-diagnosis processing.

As indicated by No. 19 in FIGS. 17 and 18A, the CPU side target control circuit 408 awaits for the target 10 from the CPU 305 to break, and transmits information to the descriptor control circuit 414 to the effect that no target IOs will occur hereafter. The CPU side target control circuit 408 performs retry response thereafter. That is to say, even if the CPU side target control circuit 408 receives new disk write instructions or disk read instructions, the CPU side target control circuit 408 does not send these to the descriptor control circuit 414 downstream, and accordingly does not allow new processing to occur.

As indicated by No. 20 in FIGS. 17 and 18A, the descriptor control circuit 414 transmits information to the write DMA circuit 415 to the effect that no new write DMAs will occur hereafter.

As indicated by Nos. 21 and 22 in FIGS. 17 and 18A, the write DMA circuit 415 awaits the write DMA to end, and transmits information to the memory side master control circuit 405 and CM side master control circuit 410 to the effect that no data relay due to write DMAs will occur hereafter.

As indicated by No. 23 in FIGS. 17 and 18B, the write DMA circuit 415 awaits the write DMA currently being processed to end, and transmits information to the descriptor control circuit 414 to the effect that no data relay to the CPU 305 due to write DMAs will occur hereafter. No new processing will occur at the write DMA circuit 415 hereafter, so the write DMA circuit 415 starts self-diagnosis processing.

As indicated by No. 24 in FIGS. 17 and 18B, the descriptor control circuit 414 transmits information to the read DMA circuit 416 to the effect that no read DMAs will occur hereafter.

As indicated by No. 25 in FIGS. 17 and 18B, the read DMA circuit 416 awaits the read DMA to end, and transmits information to the memory side master control circuit 405 to the effect that no data relay due to the read DMA circuit 416 will occur hereafter. No new processing will occur at the memory side master control circuit 405 hereafter, so the memory side master control circuit 405 starts self-diagnosis processing.

As indicated by No. 26 in FIGS. 17 and 18B, the read DMA circuit 416 awaits the read DMA to end, and transmits information to the CM side master control circuit 410 to the effect that no data relay due to read DMAs will occur hereafter. No new processing will occur at the CM side master control circuit 410 hereafter, so the CM side master control circuit 410 starts self-diagnosis processing.

As indicated by No. 27 in FIGS. 17 and 18B, the read DMA circuit 416 awaits the read DMA to end, and transmits information to the CM side target control circuit 411 to the effect that no data relay due to read DMAs will occur hereafter. Hereafter, the CM side target control circuit 411 performs retry response.

As indicated by No. 28 in FIGS. 17 and 18B, the read DMA circuit 416 awaits the read DMA to end, and transmits information to the descriptor control circuit 414 to the effect that no data relay to the CPU 305 due to read DMAs will occur hereafter. No new processing will occur at the read DMA circuit 416 hereafter, so the read DMA circuit 416 starts self-diagnosis processing.

As indicated by No. 29 in FIGS. 17 and 18B, there will be no data relay due to the read DMA circuit 416 or write DMA circuit 415 hereafter, so the descriptor control circuit 414 transmits information to the CPU side master control circuit 407 to the effect that no data relay to the CPU 305 will occur. No new processing will occur at the descriptor control circuit 414 or CPU side master control circuit 407 hereafter, so self-diagnosis processing is started thereat.

As indicated by Nos. 30 through 33 in FIGS. 17 and 18B, upon completion of self-diagnosis processing at the read bridge circuit 413, write bridge circuit 412, and CC side master control circuit 402, diagnosis end notifications are transmitted by each.

As indicated by No. 34 in FIGS. 17 and 18B, the self-diagnosis control circuit 417 transmits a diagnosis mode end notification to the CC side target control circuit 403. That is to say, self-diagnosis processing has ended at the circuits downstream of the CC side target control circuit 403 and there is no problem in new processing occurring, so the retry response is disengaged. The CC side target control circuit 403 ends the retry response, and performs normal processing thereafter.

As indicated by Nos. 35 through 39 in FIGS. 17 and 18B, upon completion of self-diagnosis processing at the CPU side master control circuit 407, write DMA circuit 415, read DMA circuit 416, descriptor control circuit 414, and CM side master control circuit 410, diagnosis end notifications are transmitted by each.

As indicated by No. 40 in FIGS. 17 and 18B, the self-diagnosis control circuit 417 transmits a diagnosis mode end notification to the CM side target control circuit 411. That is to say, self-diagnosis processing has ended at the circuits downstream of the CM side target control circuit 411 and there is no problem in new processing occurring, so the retry response is disengaged. The CM side target control circuit 411 ends the retry response, and performs normal processing thereafter.

As indicated by No. 41 in FIGS. 17 and 18B, the self-diagnosis control circuit 417 transmits a diagnosis mode end notification to the CPU side target control circuit 408. The CPU side target control circuit 408 ends the retry response, and performs normal processing thereafter.

As indicated by No. 42 in FIGS. 17 and 18B, the diagnosis processing ends.

### (Effects of the Third Embodiment)

As described above, with the third embodiment, all circuits within the memory controller 400 other than the CC side target control circuit 403, CPU side target control circuit 408, and CM side target control circuit 411 are the object of performing self-diagnosis processing, so the number of circuits performing self-diagnosis processing may be increased as compared with the first and second embodiments.

### 4. Fourth Embodiment

Now, with the third embodiment, description has been made regarding an arrangement wherein no new processing at all occurs after transmission of the diagnosis mode start announcement, but the present art is not restricted to this, and new processing may be allowed to occur.

Specifically, an arrangement may be made regarding circuits where new processing is allowed to occur, wherein the self-diagnosis processing is temporarily interrupted and the processing which has newly occurred is performed, and subsequently the self-diagnosis processing is restarted. Accordingly, with the fourth embodiment, a case will be described wherein the self-diagnosis processing is temporarily interrupted and the newly occurring processing is performed, following which the self-diagnosis processing is restarted. Specifically, in the following, description will be made regarding an example of a case of memory write processing or memory read processing newly occurring. That is to say, description will be made regarding a case wherein memory write processing is newly received or a memory write instruction is newly received.

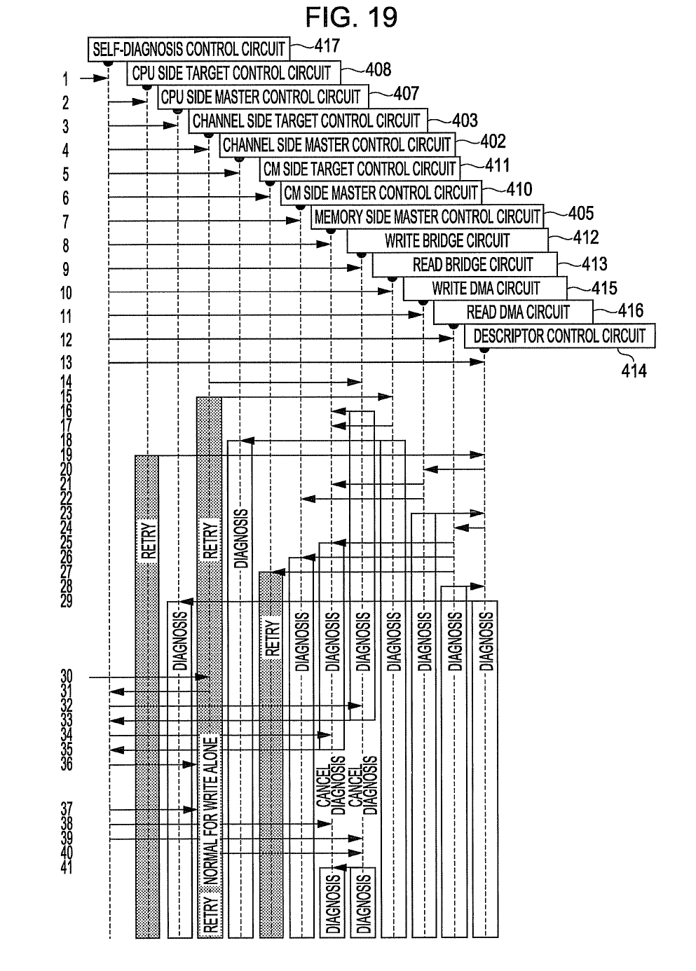

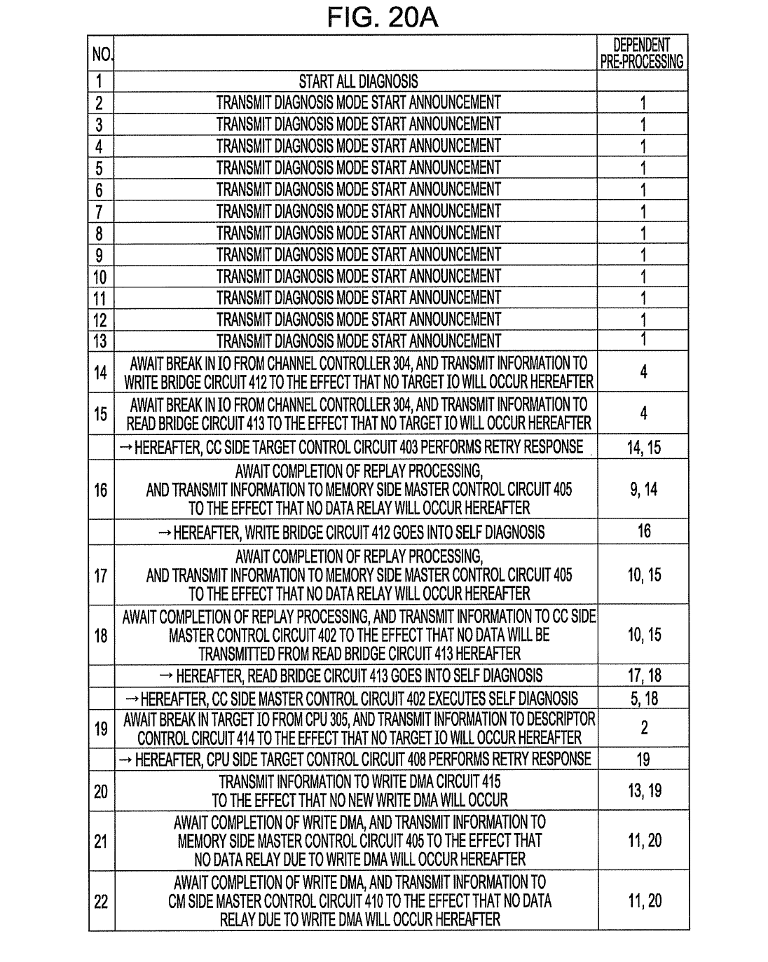

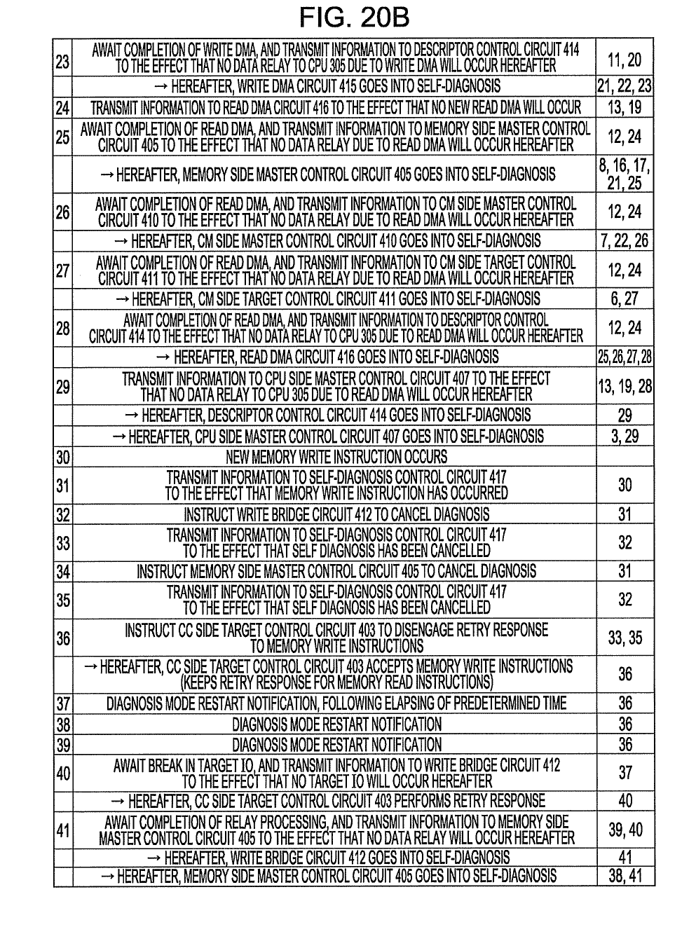

First, a case of new memory write processing occurring will be described with reference to FIGS. 19 through 20B. FIGS. 19 through 20B are diagrams for describing the flow of self-diagnosis processing in the case of permitting new memory write instructions to occur in the memory controller of the third embodiment. Also, Nos. 1 through 29 in FIGS. 19 through 20B correspond to Nos. 1 through 29 in FIGS. 17 through 18B.

As indicated by No. 30 in FIGS. 19 and 20B, upon a new memory write instruction occurring at the memory controller 400, the CC side target control circuit 403 transmits information to the self-diagnosis control circuit 417 to the effect that a memory write instruction has occurred, as indicated by No. 31 in FIGS. 19 and 20B.

As indicated by No. 32 in FIGS. 19 and 20B, the self-diagnosis control circuit 417 instructs the write bridge circuit 412 to stop diagnosis. As indicated by No. 33 in FIGS. 19 and 20B, the write bridge circuit 412 transmits information to the self-diagnosis control circuit 417 to the effect that self-diagnosis processing has been cancelled.

Also, as indicated by No. 34 in FIGS. 19 and 20B, the self-diagnosis control circuit 417 instructs the memory side master control circuit 405 to stop diagnosis processing. As indicated by No. 35 in FIGS. 19 and 20B, the memory side master control circuit 405 transmits information to the self-diagnosis control circuit 417 to the effect that self-diagnosis processing has been cancelled.

That is to say, the self-diagnosis control circuit 417 instructs the circuits which perform processing in order to carry out the memory write instruction, to cancel diagnosis processing. In other words, in the event of causing the processing circuits to interrupt the self-diagnosis processing and perform new processing, the self-diagnosis control circuit 417 transmits an interruption instruction to the processing circuits to the effect that the self-diagnosis processing is to be interrupted. Also, upon receiving the interruption instruction from the self-diagnosis control circuit 417 following having receiving the start instruction, the processing circuits interrupt their self-diagnosis processing, and perform the processing newly occurring thereat.

As indicated by No. 36 in FIGS. 19 and 20B, the self-diagnosis control circuit 417 transmits information to the CC side target control circuit 403 to the effect that the retry response as to memory write instructions is to be disengaged. That is to say, in the event of causing the processing circuits to interrupt their self-diagnosis processing and perform new processing, the self-diagnosis control circuit 417 transmits an interruption instruction to the upstream circuits to the effect that self-diagnosis processing is to be interrupted. Subsequently, the CC side target control circuit 403 receives the memory write instruction. That is to say, upon receiving an interruption instruction from the self-diagnosis control circuit 417 following having received a start instruction, the CC side target control circuit 403 interrupts the processing of preventing new processing from occurring at the processing circuits, and performs processing such that new processing occurs a the processing circuits. Note that the CC side target control circuit 403 maintains the retry response as to memory read instructions.

As indicated in No. 37 in FIGS. 19 and 20B, upon a predetermined amount of time elapsing from accepting of the memory write instruction, the self-diagnosis control circuit 417 transmits a diagnosis mode restart announcement as indicated in Nos. 37 through 39 in FIGS. 19 and 20B. That is to say, in the case of restarting the self-diagnosis processing following interruption of the self-diagnosis processing, the self-diagnosis control circuit 417 transmits a restart instruction to the upstream circuits and processing circuits to the effect that the self-diagnosis processing is to be restarted. Specifically, the self-diagnosis control circuit 417 transmits a diagnosis mode restart announcement to the write bridge circuit 412, memory side master control circuit 405, and CC side target control circuit 403. Note that a diagnosis mode restart announcement is an instruction to the effect that the diagnosis mode is to be restarted.

As indicated in No. 40 in FIGS. 19 and 20B, the CC side target control circuit 403 awaits for the channel/target IOs to break, and transmits information to the write bridge circuit 412 to the effect that no new target IOs will occur hereafter. Thereafter, the CC side target control circuit 403 performs retry response. That is to say, upon receiving a restart instruction from the self-diagnosis control circuit 417 following receiving the interruption instruction, the upstream circuits restart keeping new processing from occurring at the processing circuits.

As indicated in No. 41 in FIGS. 19 and 20B, the write bridge circuit 412 awaits for the relay processing to end, and transmits information to the memory side master control circuit 405 to the effect that no data relay will occur hereafter. Thereafter, no new processing will occur at the write bridge circuit 412 and memory side master control circuit 405, so self-diagnosis processing is started thereat. That is to say, upon receiving a restart instruction from the self-diagnosis control circuit 417 following receiving the interruption instruction, the processing circuits restart the self-diagnosis processing once the processing which has newly occurred thereat ends.

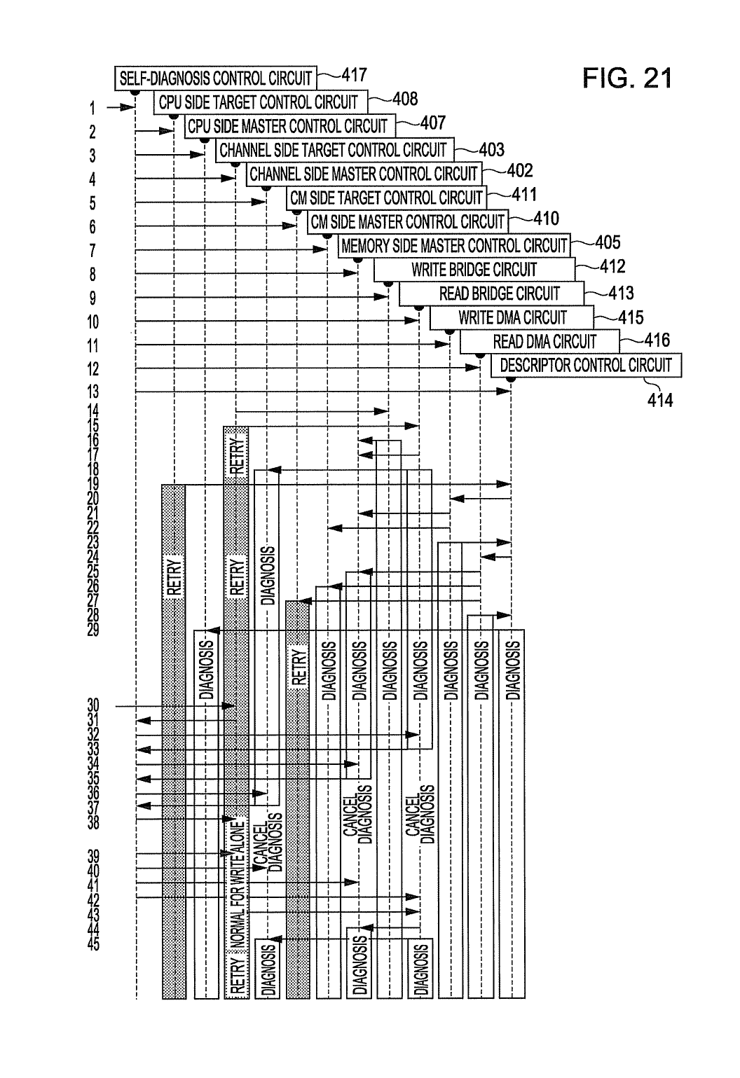

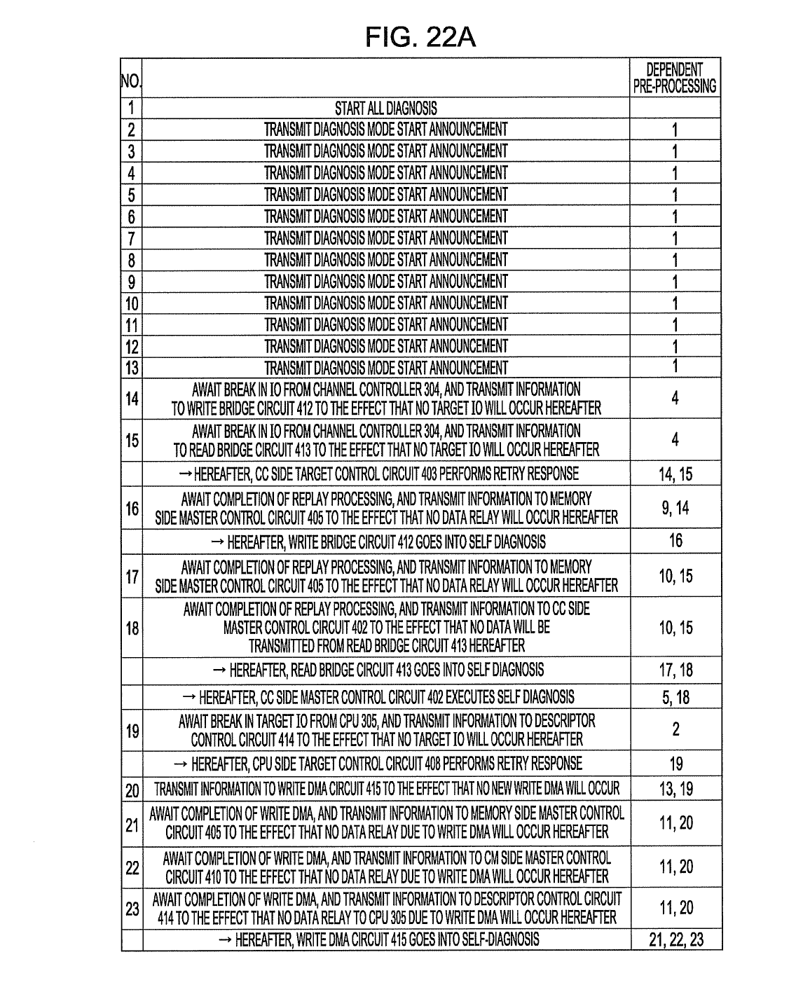

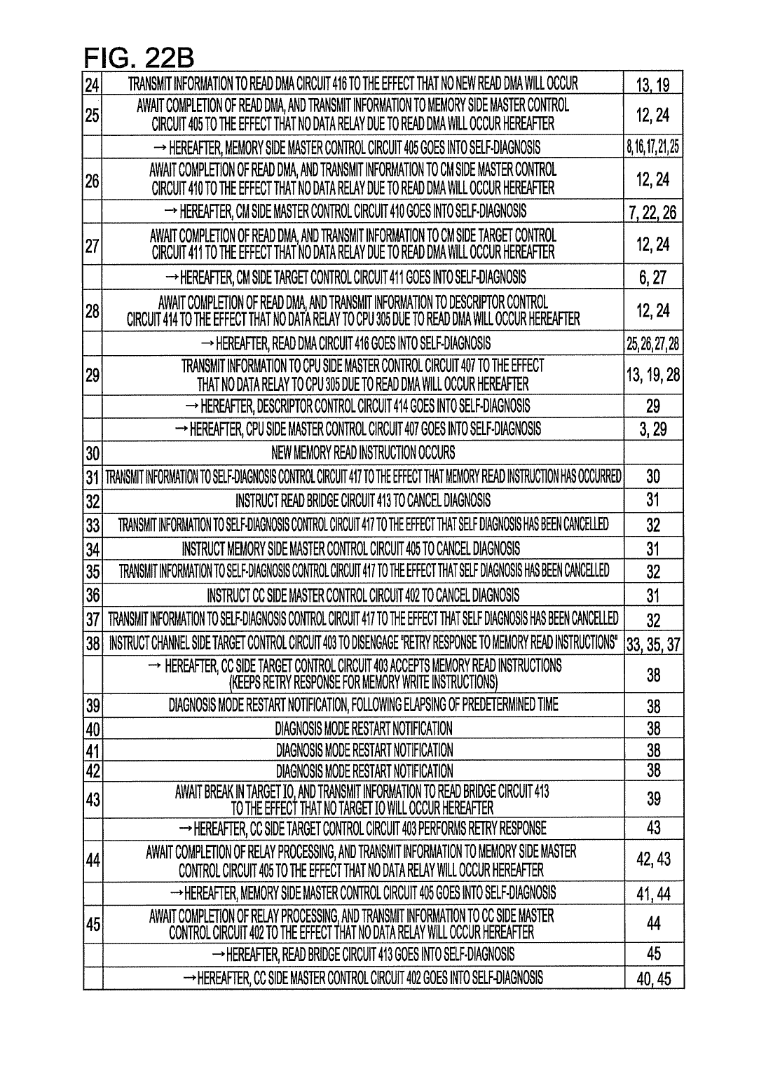

Next, a case of new memory read processing occurring will be described with reference to FIGS. 21 through 22B. FIGS. 21 through 22B are diagrams for describing the flow of self-diagnosis processing in the case of permitting new memory read instructions to occur in the memory controller of the third embodiment. Also, Nos. 1 through 29 in FIGS. 21 through 22B correspond to Nos. 1 through 29 in FIGS. 17 through 18B.

As indicated by No. 30 in FIGS. 21 and 22B, upon a new memory write instruction occurring at the memory controller 400, the CC side target control circuit 403 transmits information to the self-diagnosis control circuit 417 to the effect that a memory read instruction has occurred, as indicated by No. 31 in FIGS. 21 and 22B.

As indicated by No. 32 in FIGS. 21 and 22B, the self-diagnosis control circuit 417 instructs the read bridge circuit 413 to stop diagnosis processing. As indicated by No. 33 in FIGS. 21 and 22B, the read bridge circuit 413 transmits information to the self-diagnosis control circuit 417 to the effect that self-diagnosis processing has been cancelled.

Also, as indicated by No. 34 in FIGS. 21 and 22B, the self-diagnosis control circuit 417 instructs the memory side master control circuit 405 to stop diagnosis processing. As indicated by No. 35 in FIGS. 21 and 22B, the memory side master control circuit 405 transmits information to the self-diagnosis control circuit 417 to the effect that self-diagnosis processing has been cancelled.

That is to say, the self-diagnosis control circuit 417 instructs the circuits which perform processing in order to carry out the memory read instruction, to cancel diagnosis.

As indicated by No. 36 in FIGS. 21 and 22B, the self-diagnosis control circuit 417 instructs the CC side master control circuit 402 to cancel diagnosis processing, and as indicated by No. 37 in FIGS. 21 and 22B, the CC side master control circuit 402 transmits information to the self-diagnosis control circuit 417 to the effect that self-diagnosis has been cancelled.

Also, as indicated by No. 38 in FIGS. 21 and 22B, the self-diagnosis control circuit 417 instructs the CC side target control circuit 403 to the effect that the retry response as to memory read instructions is to be disengaged. Subsequently, the CC side target control circuit 403 receives the external memory read instruction. Note that the CC side target control circuit 403 maintains the retry response as to memory write instructions.

As indicated in No. 39 in FIGS. 21 and 22B, upon a predetermined amount of time elapsing from accepting of the memory read instruction, the self-diagnosis control circuit 417 transmits a diagnosis mode restart announcement as indicated in Nos. 39 through 42 in FIGS. 21 and 22B. Specifically, the self-diagnosis control circuit 417 transmits a diagnosis mode restart announcement to the read bridge circuit 413, memory side master control circuit 405, CC side master control circuit 402, and CC side target control circuit 403.

As indicated in No. 43 in FIGS. 21 and 22B, the CC side target control circuit 403 awaits for the channel/target IOs to break, and transmits information to the read bridge circuit 413 to the effect that no new target IOs will occur hereafter. Thereafter, the CC side target control circuit 403 performs retry response.

As indicated in No. 44 in FIGS. 21 and 22B, the read bridge circuit 413 awaits for the relay processing to end, and transmits information to the memory side master control circuit 405 to the effect that no data relay will occur hereafter. Thereafter, no new processing will occur at the memory side master control circuit 405, so the memory side master control circuit 405 starts self-diagnosis processing.

As indicated in No. 44 in FIGS. 21 and 22B, the read bridge circuit 413 awaits for the relay processing to end, and transmits information to the CC side master control circuit 402 to the effect that no data relay will occur hereafter. Thereafter, as indicated in No. 45 in FIGS. 21 and 22B, no new processing will occur at the CC side master control circuit 402, so the CC side master control circuit 402 starts self-diagnosis processing. Also, no new processing will occur at the read bridge circuit 413, so the read bridge circuit 413 starts self-diagnosis processing.

### (Effects of the Fourth Embodiment)

As described above, with the fourth embodiment, self-diagnosis processing may be temporarily interrupted and newly occurring processing performed.

### 5. Fifth Embodiment

Now, while embodiments have been described regarding the present art, other embodiments may be made regarding the present art other than the above-described. The following is a description of other embodiments.

### (Retry Response)

For example, while the first through fourth embodiments has been described with reference to a case in which retry response is performed, the present art is not restricted to this arrangement, and an arrangement may be made wherein, for example, the new instruction is received, and then the start of the new processing is frozen.

### (New Instruction)

Specifically, upon receiving a new instruction after receiving the diagnosis mode start announcement, the upstream circuits store the new instruction in a predetermined storage unit, but do not start processing corresponding to the received instruction. Subsequently, upon receiving a diagnosis mode end notification, the upstream circuits start processing corresponding to the new instruction stored in the predetermined storage unit.

Also, while description has been made in the fourth embodiment for example, regarding a case wherein new processing is allowed to occur, an arrangement may be made wherein new processing is allowed to occur only in cases where predetermined conditions are satisfied. For example, an arrangement may be made wherein the self-diagnosis control circuit 417 has a timer, and measures time elapsing from the point in time of the timing for starting self-diagnosis processing. At a certain processing timing therein, the self-diagnosis control circuit 417 determines whether or not the elapsed time has passed the predetermined time at No. 30 in FIG. 20B for example, and permits new processing to occur only in the event that the elapsed time has not passed the predetermined time. Also, an arrangement wherein the self-diagnosis control circuit 417 measures the time elapsing from the point in time of the timing for starting self-diagnosis processing may prevent a situation wherein an end notification is not made to the host server 100 for a long time.

(In the Event that an Error is Included in the Diagnosis Results)

Also, in the event that an error is included in the diagnosis results, the CPU 305 resends an activation instruction to the load device 303, so as to reload the circuit information to the circuit-configuring memory which the memory controller 400 has. This may resolve errors included in circuits.

Also, an arrangement may be made wherein the circuits within the memory controller 400 uses past error contents to change the contents of diagnosis to be performed in the self-diagnosis processing. For example, in the event that errors have occurred from bit sticking, diagnosis processing may be made particularly focused on bit sticking.

### (Diagnosis Processing for the Self-Diagnosis Control Circuit)

Also, for example, diagnosis processing may be further performed regarding the self-diagnosis control circuit 417. For example, the self-diagnosis control circuit 417 does not perform processing except for the timing for performing self-diagnosis processing, so the self-diagnosis control circuit 417 may perform self-diagnosis processing at times of not performing self-diagnosis processing. This may prevent situations wherein errors occur in the circuit information of the self-diagnosis control circuit 417 and the self-diagnosis processing of the circuits within the memory controller 400 is not started properly, or the diagnosis results thereof are not processed properly.

Also, for example, an arrangement may be made wherein the self-diagnosis control circuit 417 is not realized by loading circuit information onto a programmable device, but rather is realized using an ASIC (Application Specific Integrated Circuit) or the like. Now, in the case of using a programmable device, the product may be shipped as soon as the circuit information is created. While arrangements using ASICs desire that an actual circuit has to be fabricated following creating of the circuit information, the probability of errors occurring as a result of the effect of neutron beams or the like is lower than with the case of a circuit realized on a programmable device.

Accordingly, since self-diagnosis processing does not function properly if there are errors at the self-diagnosis control circuit 417, an arrangement may be made wherein the self-diagnosis control circuit 417 is realized using an ASIC or the like, thereby realizing both reliability of the circuit and reduction in time from manufacturing to shipping (time to market).

### (Combination of the Embodiments)

Also, with the above-described embodiments, an arrangement wherein a technique for the processing circuits to start self-diagnosis processing of themselves upon ending the processing to be performed thereat, and a technique for the upstream circuits to keep new processing from occurring, are carried out together, has been described. However, the present art is not restricted to this arrangement, and an arrangement may be made wherein the technique in which the processing circuits start self-diagnosis processing of themselves upon ending the processing to be performed thereat alone is carried out.

### (Construction of the System)

Also, in the processing of the embodiments, part or all of the processing described as being performed automatically may be performed manually, and part or all of the processing described as being performed manually may be performed automatically with known methods. For example, the timing at which to start the self-diagnosis processing may be specified manually.

Moreover, the processing procedures, control procedures, specific nomenclature, and information including various types of data and parameters, within the specification and the drawings, may be optionally changed unless specifically stated (FIGS. 1 through 22B).

Also, the components of the devices illustrated in the drawings are functional concepts, and do not have to be physically configured as illustrated. That is to say, specific arrangements of the devices, such as separating and integrating thereof, are not restricted to the illustrations in the drawings, and all or part thereof may be functionally or physically separated or integrated in optional increments in accordance with various types of loads, usage situations, and so on.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A storage system for controlling a storage device to store data from a host system, the storage system comprising:
a storage controller for controlling to write to or read data from the storage device;
a memory for temporally storing data during performing a data relay processing between the host system and the storage device; and
a relay device for performing the data relay processing using the memory, the relay device includes:
a plurality of processing circuits for performing the data relay processing cooperatively; and
a self-diagnosis controller for controlling each of the processing circuits to start independently a self-diagnosis processing upon completion of the processing by each of the processing circuit.

2. The storage system according to claim 1, wherein
the self-diagnosis controller transmits a start instruction to the processing circuits, and
each of the processing circuits, after receiving the start instruction from the self-diagnosis controller, starts the self-diagnosis processing once the processing to be performed by each of the processing circuits is completed.

3. The storage system according to claim 1, further comprising:
an upstream circuit for performing processing upstream of processing performed by each of the processing circuits; and wherein
the self-diagnosis controller transmits a start instruction to the upstream circuits and the processing circuits,
the upstream circuit, upon receiving a start instruction from the self-diagnosis controller, starts processing such that no new processing occurs at the processing circuits, and
each of the processing circuits, after receiving the start instruction from the self-diagnosis controller, starts the self-diagnosis processing once the processing to be performed by each of the processing circuits is completed.

4. The storage system according to claim 3, wherein
the self-diagnosis controller transmits an interruption instruction to the upstream circuits and the processing circuits in the event that the self-diagnosis controller causes the processing circuits to interrupt their self-diagnosis processing and perform new processing,
the upstream circuit, upon receiving the interruption instruction from the self-diagnosis controller, interrupts keeping new processing from occurring at the processing circuits, and
each of the processing circuits, upon receiving the interruption instruction from the self-diagnosis controller, interrupts their self-diagnosis processing and performs the processing which has newly occurred thereat.

5. The storage system according to claim 3, wherein
the self-diagnosis controller transmits a restart instruction to the upstream circuits and the processing circuits in the event of restarting the self-diagnosis processing following interrupting of the self-diagnosis processing,
the upstream circuit, upon receiving the restart instruction from the self-diagnosis controller following having received the interruption instruction, restarts keeping new processing from occurring at the processing circuits, and
each of the processing circuits, upon receiving the restart instruction from the self-diagnosis controller following having received the interruption instruction, restarts the self-diagnosis processing once the processing which has newly occurred is completed.

6. An adapter transferring data between a host system and a storage device, the adapter comprising:
a memory for temporally storing data during transferring the data between the host system and the storage device;
a plurality of processing circuits for performing the data transfer processing; and
a self-diagnosis controller for controlling each of the processing circuits to start independently a self-diagnosis processing upon completion of the processing by each of the processing circuit.

7. The adapter according to claim 6, wherein
the self-diagnosis controller transmits a start instruction to the processing circuits, and
each of the processing circuits, after receiving the start instruction from the self-diagnosis controller, starts the self-diagnosis processing once the processing to be performed by each of the processing circuits is completed.

8. The adapter according to claim 6, further comprising:
an upstream circuit for performing processing upstream of processing performed by each of the processing circuits; and wherein
the self-diagnosis controller transmits a start instruction to the upstream circuits and the processing circuits,
the upstream circuit, upon receiving a start instruction from the self-diagnosis controller, starts processing such that no new processing occurs at the processing circuits, and
each of the processing circuits, after receiving the start instruction from the self-diagnosis controller, starts the self-diagnosis processing once the processing to be performed by each of the processing circuits is completed.

9. The adapter according to claim 8, wherein
the self-diagnosis controller transmits an interruption instruction to the upstream circuits and the processing circuits in the event that the self-diagnosis controller causes the processing circuits to interrupt their self-diagnosis processing and perform new processing,
the upstream circuit, upon receiving the interruption instruction from the self-diagnosis controller, interrupts keeping new processing from occurring at the processing circuits, and
each of the processing circuits, upon receiving the interruption instruction from the self-diagnosis controller, interrupts their self-diagnosis processing and performs the processing which has newly occurred thereat.

10. The adapter according to claim 8, wherein
the self-diagnosis controller transmits a restart instruction to the upstream circuits and the processing circuits in the event of restarting the self-diagnosis processing following interrupting of the self-diagnosis processing,
the upstream circuit, upon receiving the restart instruction from the self-diagnosis controller following having received the interruption instruction, restarts keeping new processing from occurring at the processing circuits, and
each of the processing circuits, upon receiving the restart instruction from the self-diagnosis controller following having received the interruption instruction, restarts the self-diagnosis processing once the processing which has newly occurred is completed.

11. A diagnosis processing method for performing diagnosis processing of an adapter in a storage system, the adapter includes a plurality of processing circuits transferring data between a host system and the storage device, the diagnosis processing method comprising;
performing the data transfer processing by the processing circuits; and
controlling, by a self-diagnosis controller, each of the processing circuits to start independently a self-diagnosis processing upon completion of the processing by each of the processing circuit.

12. The diagnosis processing method according to claim 11, further comprising:
transmitting a start instruction from the self-diagnosis controller to the processing circuits, and
each of the processing circuits, after receiving the start instruction from the self-diagnosis controller, starting the self-diagnosis processing once the processing to be performed by each of the processing circuits is completed.
